(19) United States
(12) Patent Application Publication
(10) Pub. No.: US 2017/0194837 A1
(43) Pub. Date: Jul. 6, 2017

(54) ENERGY CONVERSION SYSTEMS AND METHODS

(71) Applicants: Gary Steven Sichau, Chelmsford, MA (US); Zygmunt Michna, New Hartford, CT (US)

(72) Inventors: Gary Steven Sichau, Chelmsford, MA (US); Zygmunt Michna, New Hartford, CT (US)

(21) Appl. No.: 14/582,250

(22) Filed: Dec. 24, 2014

(51) Int. Cl. H02K 7/18; H02J 3/38; H02S 20/32; F03B 13/18; F03D 9/25

(52) U.S. Cl. CPC H02K 7/1876; H02K 7/183; F03B 13/1845; F03D 9/25; H02S 20/32; H02J 3/38

(57) ABSTRACT

Energy conversion systems and methods are provided that comprise at least one or more of at least one solar converter that converts solar energy of sunlight into electricity, at least one wind converter that converts kinetic energy of wind into the electricity, and/or at least one wave converter that converts kinetic energy of waves of a body of water into the electricity.

### RELATED APPLICATION

This application claims the benefit of U.S. provisional patent application No. 61/964,214 filed Dec. 27, 2013, the contents of which are incorporated by reference in their entirety.

### FIELD OF THE INVENTIVE CONCEPTS

The subject inventive concepts relate to systems and methods used in the field of energy conversion. Specifically, the inventive concepts relate to systems and methods for converting wave energy, wind energy and solar energy into electricity.

### BACKGROUND OF THE INVENTIVE CONCEPTS

There have been attempts to create feasible alternatives to traditional fossil fuels used for creating electricity, such as by utilizing the power of ocean waves, wind power or solar energy to produce electricity, but these conventional devices fail to address a number of serious economic and environmental issues.

There is currently a need for, and a lack of an economically feasible and environmentally safe clean energy system and method for converting multiple sources of sustainable, renewable energy into electricity utilizing a single geographic footprint and single infrastructure to convert multiple sources of renewable energy into electricity whereby reducing the cost of the production of electricity.

There is a need for, and a lack of a dynamic clean energy system and method which continuously measures environmental conditions and automatically adjusts the operating parameters in order to maximize the production of electricity relative to changing environmental conditions.

There is a need for, and a lack of an economically feasible clean energy system and method for converting multiple sources of sustainable, renewable energy into electricity utilizing a single geographic footprint without requiring the use of habitable or cultivatable land.

There is a need for, and a lack of a nonintrusive clean energy system and method for converting multiple sources of sustainable, renewable energy into electricity which does not create an eyesore or public nuisance to populated residential neighborhoods, which does not adversely affect the neighboring wildlife ecosystems by emitting electromagnetic fields into the proximate aquatic environment, and which does not encroaching on the natural habitats of indigenous wildlife species.

In addition, there is a need for, and a lack of an economically feasible clean energy system and method for converting multiple sources of sustainable, renewable energy into electricity which does not require a land-based geographic footprint, in that land-based geographic footprints which satisfy the physical requirements for energy production are difficult to find, difficult to gain zoning permits, costly to procure and costly to develop.

### BRIEF SUMMARY OF THE INVENTIVE CONCEPTS

Conventional energy conversion devices which attempt to generate electricity from either wave energy, wind energy or solar energy are inefficient since conventional devices only capture a small percentage of the wave energy, wind energy or solar energy available in one location at any given time. This is due to the static nature of the design of these conventional devices which do not allow for the automatic adjustment of their operating parameters to maximize energy production in varying environmental conditions. U.S. Pat. No. 8,378,511 issued to Sichau et al. on Feb. 19, 2013 attempts to address this issue with regard to maximizing the conversion of ocean wave energy into electricity.

Conventional devices are designed to generate an estimated energy output given optimal predetermined environmental conditions. When environmental conditions are not optimal, the operating parameters of these conventional devices cannot adjust to maximize energy production under changing environmental conditions, such as when wave amplitudes and frequencies are above or below a predetermined range, or when wind velocities are above or below a predetermined range, or when the position of the sun changes. The static design of these conventional devices limits the utilization of only a small percentage of the available wave energy, wind energy or solar energy at any given time or place. The remainder of the wave energy, wind energy or solar energy remains unutilized and is forever lost.

The present inventive concepts are dynamic in design rather than static in that they continuously measure environmental conditions and adjust the operating parameters to maximize the electricity produced from available sources of wave energy, wind energy and/or solar energy.

In the case of kinetic energy of a body of water, also referred to as wave energy, the system includes an assembly of conductive coils adjacent or at least partially surrounding a magnetic assembly having a magnetic field, where the magnetic assembly moves in response to the oscillations of the waves. As the magnetic assembly moves, the conductive coils of the coil assembly pass through the magnetic field of the magnetic assembly generating an electrical charge in the conductive coils. The amount of electricity generated within the conductive coils is dependent upon the strength of the magnetic field and upon the velocity of the magnetic field as it passes the conductive coils. The system continuously measures the rate of oscillation and the vertical force of the waves of a body of water and adjusts the magnetic strength of the system to optimize the amount of electricity generated per oscillation relative to the vertical force of the waves whereby controlling the rate of oscillation which in turn maximizes the electricity generated from the waves at any point in time. If the rate of oscillation or vertical force of the waves is less than an optimal level, the system decreases the magnetic strength of the magnetic assembly to increase the velocity of magnetic assembly moving relative to the coil assembly to an optimal rate for maximizing the electricity generated relative to the vertical force of the waves. If the rate of oscillation or vertical force of the waves is greater than the optimal level, the system increases the magnetic strength of the magnetic assembly to maximize the electricity generated relative to the vertical force of the waves while decreasing the velocity of the magnetic assembly to an optimal velocity.

In the case of kinetic energy of wind also referred to as wind energy, the system includes an assembly of conductive coils adjacent or at least partially surrounding a magnetic assembly coupled to an axel. Wind collectors are coupled to the axel and rotate the axel in response to a horizontal force applied on the wind collectors by the wind, whereby moving the magnetic assembly. As the magnetic assembly rotates, the conductive coils pass through the magnetic field of the magnetic assembly generating an electrical charge in the conductive coils. The amount of electricity generated within the conductive coils is dependent upon the strength of the magnetic field and upon the rate at which the magnetic field passes the conductive coils. The system continuously measures the direction of the wind and adjusts the orientation of the wind collectors to maximize the horizontal force applied against the system. The system also continuously measures the horizontal force applied against the wind collects and adjusts the magnetic strength of the system to optimize the amount of electricity generated relative to the horizontal force applied by the wind whereby controlling the rate of rotation which in turn maximizes the electricity generated by the wind at any point in time. If the horizontal force applied by the wind is less than an optimal level, the system decreases the magnetic strength of the magnetic assembly to increase the rotation rate of the magnetic assembly to an optimal rate for maximizing the electricity generated relative to the horizontal force applied by the wind. If the horizontal force applied by the wind is greater than the optimal level, the system increases the magnetic strength of the magnetic assembly to maximize the electricity generated relative to the horizontal force while decreasing the rotation rate of the magnetic assembly to an optimal rate.

In the case of solar energy of sunlight, the amount of electricity produced depends directly upon the amount of direct exposure to sunlight the solar receptors receive and the intensity of the exposure. The present inventive concepts continuously measure the direction and position of the sun and adjust the position of the solar receptors to optimize their exposure to direct sunlight whereby maximizing the electricity generated from the solar energy at any point in time. The present inventive concepts not only adjust the orientation of the solar receptors to optimize exposure to the sunlight, but also concentrate the solar energy to maximize the electricity generated per square foot of surface area on a solar receptor, whereby reducing the size requirements and cost of the solar receptors.

The present inventive concepts are also self-priming in that they generate the power required to operate the systems without the need for externally supplied power.

Unlike conventional devices, the present inventive concepts use the same structure and geographic footprint to convert more than one sustainable, renewable energy source into electricity. The present inventive concepts convert the kinetic energy of waves, the kinetic energy of wind and solar energy into electricity whereby increasing and maximizing the energy produced per square foot of geographic footprint without producing a pollution by-product. In addition, the present inventive concepts convert wave, wind and solar energy into electricity using the same support structure and support systems to generate, store, and transfer the electricity generated by the system. This shared utilization of the geographic footprint, support structure and support systems greatly reduces equipment cost, capital costs, and maintenance costs.

Furthermore, the present inventive concept can be fully constructed at land-based facilitates and towed via ship to designated off-shore locations. The utilization of water-based geographic footprints greatly reduces or eliminates the cost of leasing or purchasing expensive land-based footprints, and enables the present inventive concepts to be located far off-shore away from residential areas and vulnerable wildlife areas. This eliminates issues of nuisance, noise pollution and eyesore complaints arising from conventional devices being constructed near residential areas. The present inventive concepts also eliminate environmental concerns regarding the effect of electromagnetic fields on the aquatic eco-system in that none of the system's electronic components are in contact with the aquatic eco-system. Furthermore, locating the system off-shore removes the system from the natural habitat of wildlife which would otherwise be displaced.

In this way, the present inventive concepts provide an unlimited, clean and renewable source of low-cost electricity to supply the growing clean energy needs of present and future generations.

It is therefore an object of the present inventive concepts to provide an energy conversion system and method for converting kinetic energy of waves of a body of water into electricity.

It is therefore an object of the present inventive concepts to provide an energy conversion system and method for converting kinetic energy of wind into electricity.

It is therefore an object of the present inventive concepts to provide an energy conversion system and method for converting solar energy into electricity.

It is therefore an object of the present inventive concepts to provide an energy conversion system and method for converting kinetic energy of waves of a body of water and kinetic energy of wind into electricity.

It is therefore an object of the present inventive concepts to provide an energy conversion system and method for converting kinetic energy of waves of a body of water and solar energy into electricity.

It is therefore an object of the present inventive concepts to provide an energy conversion system and method for converting kinetic energy of waves of a body of water, kinetic energy of wind and solar energy into electricity.

It is therefore an object of the present inventive concepts to provide an energy conversion system and method for converting kinetic energy of waves of a body of water, kinetic energy of wind and solar energy into electricity, where the energy conversion system and method does not produce pollution.

It is therefore an object of the present inventive concepts to provide an energy conversion system and method for converting kinetic energy of waves of a body of water, kinetic energy of wind and solar energy into electricity, where the energy conversion system and method does not require a renewable fuel source to operate.

It is therefore an object of the present inventive concepts to provide an energy conversion system and method for converting kinetic energy of waves of a body of water, kinetic energy of wind and solar energy into electricity, where the energy conversion system and method is self-powering and self-sustaining.

It is therefore an object of the present inventive concepts to provide an energy conversion system and method for converting kinetic energy of waves of a body of water, kinetic energy of wind and solar energy into electricity using the same geographic footprint whereby reducing capital cost.

It is therefore an object of the present inventive concepts to provide an energy conversion system and method for converting kinetic energy of waves of a body of water, kinetic energy of wind and solar energy into electricity using the same support infrastructure and components for the control, storage and transfer of the generated electricity, whereby reducing capital cost by eliminating the need for redundant support infrastructure and components.

It is a further object of the present inventive concepts to provide an energy conversion system and method which continuously measures changes in kinetic energy of waves, kinetic energy of wind and solar energy whereby maximizing the generation of electricity from kinetic energy of waves, kinetic energy of wind and solar energy at any point in time.

It is a further object of the present inventive concepts to provide an energy conversion system and method which is dynamic and whereby automatically adjusting operating parameters in response to changes in kinetic energy of waves, kinetic energy of wind and solar energy for maximizing the electricity converted from the kinetic energy of waves, kinetic energy of wind and solar energy

It is a further object of the present inventive concepts to provide an energy conversion system and method for providing an unlimited source of clean, renewable electricity converted from kinetic energy of waves, kinetic energy of wind and solar energy.

It is a further object of the present inventive concepts to provide such a system and method for converting the kinetic energy of the waves of a body of water into electricity while eliminating concerns of detrimental effects to the environment by separating electromagnetic fields from the aquatic environment.

It is a further object of the present inventive concepts to provide an energy conversion system and method for converting kinetic energy of wind and solar energy into electricity while eliminating concerns of dislocating wildlife from its natural habitat by locating the system on a water-based off-shore structure.

It is a further object of the present inventive concepts to provide such an energy conversion system and method for converting kinetic energy of wind and solar energy into electricity while eliminating an eyesore to neighboring communities by locating the system off-shore where the system cannot be seen from land.

It is a further object of the present inventive concepts to provide such an energy conversion system and method for generating low cost electricity from kinetic energy of waves, kinetic energy of wind and solar energy.

It is a further object of the present inventive concepts to provide such an energy conversion system and method for converting kinetic energy of waves, kinetic energy of wind and solar energy into electricity, where the energy conversion system and method can be located and secured on any water-based footprint.

It is a further object of the present inventive concepts to provide such an energy conversion system and method for converting kinetic energy of waves, kinetic energy of wind and solar energy into electricity, where the energy conversion system and method is modular and constructed in separable units which can be transported to a final destination and connected together to form energy conversion systems of varying size, shape and configuration.

In accordance with an aspect of the present inventive concepts, an energy conversion system comprises at least one wave converter that converts kinetic energy of waves of a body of water into electricity wherein the at least one wave converter comprises at least one floating assembly that at least partially floats on the body of water and the kinetic energy of the waves of the body of water applies a vertical force on the at least one floating assembly whereby moving the at least one floating assembly in response to the vertical force, at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, at least one magnetic assembly having at least one magnetic field having at least one magnetic strength is coupled to the at least one rod assembly whereby coupling the at least one magnetic assembly to the at least one rod assembly moves the at least one magnetic assembly in response to the vertical force applied to the at least one floating assembly, and at least one coil assembly external to the at least one rod assembly and directly adjacent the at least one magnetic assembly and the at least one magnetic assembly moves relative to the at least one coil assembly whereby generating the electricity at the at least one coil assembly.

In an embodiment of the energy conversion system wherein the at least one coil assembly comprises at least one conductive wave coil having at least one second conductive wire coiled around at least one second conductive core and the at least one conductive wave coil passes through the at least one magnetic field in response to the vertical force moving the at least one magnetic assembly whereby generating the electricity at the at least one conductive wave coil.

In an embodiment of the energy conversion system wherein the at least one magnetic assembly comprises at least one of at least one wave electromagnet or at least one wave permanent magnet.

In an embodiment of the energy conversion system further comprising a support structure coupled to the at least one wave converter that supports the at least one wave converter at least partially above the body of water.

In an embodiment of the energy conversion system wherein the support structure comprises at least one support leg having a top end and a bottom end and the bottom end is coupled to at least one of a ground surface or at least one support buoy and the top end extends above the body of water, and at least one platform having an upper surface and a lower surface and the at least one platform is coupled to the at least one support leg whereby supporting the at least one platform horizontally above the body of water.

In an embodiment of the energy conversion system further comprising at least one wave assembly controller coupled to the at least one magnetic assembly that adjusts the at least one magnetic strength of the at least one magnetic field, and at least one wave gauge in communication with the at least one wave assembly controller that measures the vertical force applied to the at least one floating assembly and the at least one wave gauge generates a vertical force signal corresponding to the vertical force and communicates the vertical force signal to the at least one wave assembly controller to adjust the at least one magnetic strength relative to the vertical force.

In an embodiment of the energy conversion system further comprising a housing having an opening and the proximal end of the at least one rod assembly extends through the opening and the housing at least partially surrounds the at least one magnetic assembly and the at least one coil assembly.

In an embodiment of the energy conversion system wherein the at least one magnetic assembly further comprises at least one power source coupled to the at least one wave electromagnet to power the at least one wave electromagnet, and at least one charger having at least one first conductive wire coiled around at least one first conductive core is coupled to the at least one power source the at least one charger is constructed and arranged to generate the electricity at the at least one charger whereby charging the at least one power source.

In an embodiment of the energy conversion system wherein the at least one coil assembly further comprises at least one wave coil magnet having at least one coil magnetic field comprising at least one of at least one coil electromagnet or at least one coil permanent magnet that generates the electricity at the at least one charger, and a coil assembly power storage unit coupled to the at least one conductive wave coil to store the electricity generated at the at least one conductive wave coil and to power the at least one wave coil magnet producing the at least one coil magnetic field and the at least one charger moves through the at least one coil magnetic field in response to the at least one floating assembly whereby generating the electricity at the at least one charger.

In an embodiment of the energy conversion system further comprising at least one current inverter in communication with the at least one coil assembly and the electricity generated at the at least one coil assembly moves in a first direction when the at least one magnetic assembly moves in an upward direction from a first position relative to the at least one coil assembly to a second position higher than the first position in response to the at least one floating assembly moving in the upward direction and the electricity generated at the at least one coil assembly moves in a second direction when the at least one magnetic assembly moves in a downward direction from a third position relative to the at least one coil assembly to a fourth position lower than the third position in response to the at least one floating assembly moving in the downward direction and the at least one current inverter converts the electricity moving in the second direction into the electricity moving in the first direction whereby all the electricity generated by the at least one magnetic assembly moving in the upward direction and in the downward direction is the electricity moving in the first direction.

In an embodiment of the energy conversion system further comprising at least one rod guide having an interior surface and an exterior surface and the exterior surface is coupled to the support structure and the interior surface at least partially surrounds the at least one rod assembly.

In an embodiment of the energy conversion system wherein the at least one rod assembly further comprises at least one rod magnet having a magnetic polarity and the interior surface of the at least one rod guide further having the magnetic polarity and the magnetic polarity of the interior surface of the at least one rod guide opposes the magnetic polarity of the at least one rod magnet to form a frictionless relationship between the at least one rod assembly and the at least one rod guide.

In an embodiment of the energy conversion system further comprising a central control unit coupled to the support structure wherein the central control unit comprises a primary power storage unit in communication with the at least one wave converter that stores the electricity, a power transformer in communication with the primary power storage unit that converts the electricity stored in the primary power storage unit into a modified electricity having a predetermined frequency waveform, and a power transfer unit in communication with the primary power storage unit and the power transformer that controls transfer of the modified electricity from the power transformer unit.

In accordance with an aspect of the present inventive concepts, an energy conversion system comprising at least one wind converter that converts kinetic energy of wind into electricity and the kinetic energy of the wind applies a horizontal force in a direction, at least one wave converter that converts kinetic energy of waves of a body of water into the electricity wherein the at least one wave converter comprises at least one floating assembly that at least partially floats on the body of water and the kinetic energy of the waves of the body of water applies a vertical force on the at least one floating assembly whereby moving the at least one floating assembly in response to the vertical force, at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, at least one magnetic assembly having at least one magnetic field having at least one magnetic strength coupled to the at least one rod assembly whereby coupling the at least one magnetic assembly to the at least one rod assembly moves the at least one magnetic assembly in response to the vertical force applied to the at least one floating assembly, and at least one coil assembly external to the at least one rod assembly and directly adjacent the at least one magnetic assembly and the at least one magnetic assembly moves relative to the at least one coil assembly whereby generating the electricity at the at least one coil assembly, and a support structure coupled to the at least one wave converter and the at least one wind converter that supports the at least one wave converter and the at least one wind converter at least partially above the body of water.

In an embodiment of the energy conversion system wherein the at least one coil assembly comprises at least one conductive wave coil having at least one second conductive wire coiled around at least one second conductive core and the at least one conductive wave coil moves relative to the at least one magnetic field in response to the at least one floating assembly whereby generating the electricity at the at least one conductive wave coil.

In an embodiment of the energy conversion system wherein the at least one magnetic assembly comprises at least one of at least one wave electromagnet or at least one wave permanent magnet.

In an embodiment of the energy conversion system wherein the support structure comprises at least one support leg having a top end and a bottom end and the bottom end is coupled to at least one of a ground surface or at least one support buoy and the top end extends above the body of water, and at least one platform having an upper surface and a lower surface and the at least one platform is coupled to the at least one support leg whereby supporting the at least one platform horizontally above the body of water.

In an embodiment of the energy conversion system further comprising a housing having an opening and the proximal end of the at least one rod assembly extends through the opening and the housing at least partially surrounds the at least one magnetic assembly and the at least one coil assembly.

In an embodiment of the energy conversion system further comprising at least one wave assembly controller coupled to the at least one magnetic assembly that adjusts the at least one magnetic strength of the at least one magnetic field, and at least one wave gauge in communication with the at least one wave assembly controller that measures the vertical force applied to the at least one floating assembly and the at least one wave gauge generates a vertical force signal corresponding to the vertical force and communicates the vertical force signal to the at least one wave assembly controller to adjust the at least one magnetic strength relative to the vertical force.

In an embodiment of the energy conversion system wherein the at least one magnetic assembly further comprises at least one power source to power the at least one wave electromagnet, and at least one charger having at least one first conductive wire coiled around at least one first conductive core and the at least one charger is constructed and arranged to generate the electricity at the at least one charger whereby charging the at least one power source.

In an embodiment of the energy conversion system wherein the at least one coil assembly further comprises at least one wave coil magnet having at least one coil magnetic field comprising at least one of at least one coil electromagnet or at least one coil permanent magnet that generates the electricity at the at least one charger, and a coil assembly power storage unit coupled to the at least one conductive wave coil to store the electricity generated at the at least one conductive wave coil and to power the at least one wave coil magnet producing the at least one coil magnetic field and the at least one charger moves through the at least one coil magnetic field in response to the at least one floating assembly whereby generating the electricity at the at least one charger.

In an embodiment of the energy conversion system further comprising at least one current inverter in communication with the at least one coil assembly and the electricity generated at the at least one coil assembly moves in a first direction when the at least one magnetic assembly moves in an upward direction from a first position relative to the at least one coil assembly to a second position higher than the first position in response to the at least one floating assembly moving in the upward direction and the electricity generated at the at least one coil assembly moves in a second direction when the at least one magnetic assembly moves in a downward direction from a third position relative to the at least one coil assembly to a fourth position lower than the third position in response to the at least one floating assembly moving in the downward direction and the at least one current inverter converts the electricity moving in the second direction into the electricity moving in the first direction whereby all the electricity generated by the at least one magnetic assembly moving in the upward direction and in the downward direction is the electricity moving in the first direction.

In an embodiment of the energy conversion system further comprising at least one rod guide having an interior surface and an exterior surface and the exterior surface is coupled to the support structure and the interior surface at least partially surrounds the at least one rod assembly.

In an embodiment of the energy conversion system wherein the at least one rod assembly further comprises at least one rod magnet having a magnetic polarity and the interior surface of the at least one rod guide further having the magnetic polarity and the magnetic polarity of the interior surface of the at least one rod guide opposes the magnetic polarity of the at least one rod magnet to form a frictionless relationship between the at least one rod assembly and the at least one rod guide.

In an embodiment of the energy conversion system wherein the at least one wind converter comprises an axel having a first axel end and a second axel end, at least one wind collector coupled to the axel that moves in response to the horizontal force whereby rotating the axel in response to the horizontal force applied to the at least one wind collector, at least one axel guide that movably supports and at least partially surrounds the axel, and the axel rotates in response to the horizontal force applied to the at least one wind collector, at least one wind magnetic assembly having at least one wind magnetic field having at least one wind magnetic strength the at least one wind magnetic assembly is coupled to the axel the at least one wind magnetic assembly moves, and at least one wind coil assembly directly adjacent and at least partially surrounding the at least one wind magnetic assembly whereby moving the at least one wind magnetic assembling relative to the at least one wind coil assembly generates the electricity at the at least one wind coil assembly.

In an embodiment of the energy conversion system wherein the at least one wind coil assembly comprises at least one conductive wind coil having at least one second conductive wind wire coiled around at least one second conductive wind core and the at least one conductive wind coil moves relative to the at least one wind magnetic field in response to the rotation of the axel whereby generating the electricity at the at least one conductive wind coil.

In an embodiment of the energy conversion system wherein the at least one wind magnetic assembly comprises at least one of at least one wind electromagnet or at least one wind permanent magnet.

In an embodiment of the energy conversion system wherein the at least one wind magnetic assembly further comprises at least one wind power source to power the at least one wind electromagnet, and at least one wind charger having at least one first conductive wind wire coiled around at least one first conductive wind core and the at least one wind charger is constructed and arranged to generate the electricity at the at least one wind charger to charge the at least one wind power source.

In an embodiment of the energy conversion system wherein the at least one wind coil assembly further comprises at least one wind coil magnet having at least one wind coil magnetic field comprising at least one of at least one wind coil electromagnet or at least one wind coil permanent magnet that generates the electricity at the at least one wind charger in response to the at least one wind charger moving through the at least one wind coil magnetic field, and a wind power storage unit coupled to the at least one conductive wind coil to store the electricity generated at the at least one conductive wind coil to power the at least one wind coil magnet producing the at least one wind coil magnetic field and the at least one wind charger moves through the at least one wind coil magnetic field in response to rotating the axel whereby generating the electricity at the at least one wind charger that charges the at least one wind power source.

In an embodiment of the energy conversion system wherein the at least one wind collector is an elongated propeller coupled to the axel and the at least one axel guide movably supports the axel horizontally whereby the axel rotates on a horizontal axis in response to the horizontal force.

In an embodiment of the energy conversion system wherein the at least one wind collector is an elongated scoop coupled to the axel and the at least one axel guide movably supports the axel vertically whereby the axel rotates on a vertical axis in response to the horizontal force.

In an embodiment of the energy conversion system wherein the at least one axle guide further comprises an interior guide surface having at least one axel guide magnet having a magnetic polarity and the axel further comprises at least one axel magnet having the magnetic polarity and the magnetic polarity of the at least one axel guide magnet opposes the magnetic polarity of the at least one axel magnet to form a frictionless relationship between the axel and the at least one axle guide.

In an embodiment of the energy conversion system wherein the at least one wind converter further comprises a wind assembly controller in communication with the at least one wind magnetic assembly that adjusts the at least one wind magnetic strength of the at least one wind magnetic field relative to the horizontal force and that positions the at least one wind converter relative to the direction applied by the kinetic energy of the wind, and a wind gauge that measures the direction and the horizontal force applied by the kinetic energy of the wind and the wind gauge generates a directional signal corresponding to the direction and communicates the directional signal to the wind assembly controller to adjust the position of the at least one wind converter relative to the direction and the wind gauge generates a horizontal force signal corresponding to the horizontal force and communicates the horizontal force signal to the wind assembly controller to adjust the at least one wind magnetic strength of the at least one wind magnetic assembly relative to the horizontal force.

In an embodiment of the energy conversion system further comprising a wind converter housing at least partially surrounding the at least one wind coil assembly, a support assembly coupled to the support structure to support the wind converter housing at least partially above the body of water, and a rotational device movably coupling the wind converter housing to the support assembly and in communication with the wind assembly controller to adjust the position of the at least one wind collector relative to the direction and the horizontal force.

In an embodiment of the energy conversion system further comprising a central control unit coupled to the support structure wherein the central control unit comprises a primary power storage unit coupled to the at least one wave converter and the at least one wind converter to store the electricity, a power transformer coupled to the primary power storage unit to convert the electricity into a modified electricity having a predetermined frequency wave form, a power transfer unit coupled to the primary power storage unit and the power transformer to control output of the modified electricity, and a primary controller coupled to the primary power storage unit and in communication with the at least one wave converter and the at least one wind converter to monitor and control the at least one wave converter and the at least one wind converter.

In accordance with an aspect of the present inventive concepts, an energy conversion system comprising at least one solar converter that converts solar energy of sunlight into electricity and the solar energy of the sunlight having a solar coordinate, at least one wave converter that converts kinetic energy of waves of a body of water into the electricity wherein the at least one wave converter comprises at least one floating assembly that at least partially floats on the body of water and the kinetic energy of the waves of the body of water applies a vertical force on the at least one floating assembly whereby moving the at least one floating assembly in response to the vertical force, at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, at least one magnetic assembly having at least one magnetic field having at least one magnetic strength coupled to the at least one rod assembly whereby coupling the at least one magnetic assembly to the at least one rod assembly moves the at least one magnetic assembly in response to the vertical force applied to the at least one floating assembly, and at least one coil assembly external to the at least one rod assembly and directly adjacent the at least one magnetic assembly and the at least one magnetic assembly moves relative to the at least one coil assembly whereby generating the electricity at the at least one coil assembly, and a support structure coupled to the at least one wave converter and the at least one solar converter that supports the at least one wave converter and the at least one solar converter at least partially above the body of water.

In an embodiment of the energy conversion system wherein the at least one coil assembly comprises at least one conductive wave coil having at least one second conductive wire coiled around at least one second conductive core and the at least one conductive wave coil moving relative to the at least one magnetic field in response to the at least one floating assembly whereby generating the electricity at the at least one conductive wave coil.

In an embodiment of the energy conversion system wherein the at least one magnetic assembly comprises at least one of at least one wave electromagnet or at least one wave permanent magnet.

In an embodiment of the energy conversion system wherein the support structure comprises at least one support leg having a top end and a bottom end and the bottom end is coupled to at least one of a ground surface or at least one support buoy and the top end extends above the body of water, and at least one platform having an upper surface and a lower surface and the at least one platform is coupled to the at least one support leg whereby supporting the at least one platform horizontally above the body of water.

In an embodiment of the energy conversion system further comprising a housing having an opening wherein the proximal end of the at least one rod assembly extends through the opening and the housing at least partially surrounds the at least one magnetic assembly and the at least one coil assembly.

In an embodiment of the energy conversion system further comprising at least one wave assembly controller coupled to the at least one magnetic assembly that adjusts the at least one magnetic strength of the at least one magnetic field, and at least one wave gauge in communication with the at least one wave assembly controller that measures the vertical force applied to the at least one floating assembly and the at least one wave gauge generates a vertical force signal corresponding to the vertical force and communicates the vertical force signal to the at least one wave assembly controller to adjust the at least one magnetic strength relative to the vertical force.

In an embodiment of the energy conversion system wherein the at least one magnetic assembly further comprises at least one power source to power the at least one wave electromagnet, and at least one charger having at least one first conductive wire coiled around at least one first conductive core and the at least one charger is constructed and arranged to generate the electricity at the at least one charger whereby charging the at least one power source.

In an embodiment of the energy conversion system wherein the at least one coil assembly further comprises at least one wave coil magnet having at least one coil magnetic field comprising at least one of at least one coil electromagnet or at least one coil permanent magnet that generates the electricity at the at least one charger, and a coil assembly power storage unit coupled to the at least one conductive wave coil to store the electricity generated at the at least one conductive wave coil and to power the at least one wave coil magnet producing the at least one coil magnetic field and the at least one charger moves through the at least one coil magnetic field in response to the at least one floating assembly whereby generating the electricity at the at least one charger.

In an embodiment of the energy conversion system further comprising at least one current inverter in communication with the at least one coil assembly and the electricity generated at the at least one coil assembly moves in a first direction when the at least one magnetic assembly moves in an upward direction from a first position relative to the at least one coil assembly to a second position higher than the first position in response to the at least one floating assembly moving in the upward direction and the electricity generated at the at least one coil assembly moves in a second direction when the at least one magnetic assembly moves in a downward direction from a third position relative to the at least one coil assembly to a fourth position lower than the third position in response to the at least one floating assembly moving in the downward direction and the at least one current inverter converts the electricity moving in the second direction into the electricity moving in the first direction whereby all the electricity generated by the at least one magnetic assembly moving in the upward direction and in the downward direction is the electricity moving in the first direction.

In an embodiment of the energy conversion system further comprising at least one rod guide having an interior surface and an exterior surface and the exterior surface is coupled to the support structure and the interior surface at least partially surrounds the at least one rod assembly.

In an embodiment of the energy conversion system wherein the at least one rod assembly further comprises at least one rod magnet having a magnetic polarity and the interior surface of the at least one rod guide further having the magnetic polarity and the magnetic polarity of the interior surface of the at least one rod guide opposes the magnetic polarity of the at least one rod magnet to form a frictionless relationship between the at least one rod assembly and the at least one rod guide.

In an embodiment of the energy conversion system wherein the at least one solar converter comprises at least one solar receptor having an absorbing surface and a non-absorbing surface and the absorbing surface collects the solar energy of the sunlight and converts the solar energy of the sunlight into the electricity.

In an embodiment of the energy conversion system further comprising at least one rotator coupled to the support structure to position the absorbing surface of the at least one solar receptor from a first coordinate to a second coordinate and the first coordinate having a first direction and a first angle and the second coordinate having a second direction and a second angle whereby moving the at least one rotator from the first coordinate to the second coordinate changes at least one of the first direction or the first angle to at least one of the second direction or the second angle, a positioning arm having a first length movably coupling the at least one rotator to the non-absorbing surface of the at least one solar receptor to move the at least one solar receptor, a controller in communication with the at least one rotator to position the absorbing surface of the at least one solar receptor and the controller signals the at least one rotator to move the positioning arm whereby moving the absorbing surface of the at least one solar receptor from the first coordinate to the second coordinate, and at least one solar gauge movably coupled to the support structure and in communication with the controller and the at least one solar gauge calculates the solar coordinate of the solar energy of the sunlight having a solar direction and a solar angle and the at least one solar gauge calculates an optimal coordinate of the absorbing surface having an optimal direction and an optimal angle and the optimal coordinate of the absorbing surface is a predetermined solar angle of the absorbing surface of the at least one solar receptor relative to the solar coordinate and the at least one solar gauge generates a positioning signal corresponding to the optimal coordinate and communicates the positioning signal to the controller whereby the controller moves the at least one solar receptor to maximize the solar energy collected by the absorbing surface.

In an embodiment of the energy conversion system wherein the positioning arm comprises at least one extending segment to adjust the first length of the positioning arm and the controller signals the at least one rotator to extend the positioning arm whereby lengthening the positioning arm from the first length to a second length and the controller signals the at least one rotator to retract the positioning arm whereby shortening the positioning arm from the second length to the first length.

In an embodiment of the energy conversion system comprises at least one magnifying lens having a first surface area coupled to the at least one solar receptor and fixed adjacent the absorbing surface having a second surface area and the first surface area is greater than the second surface area whereby the solar energy of the sunlight passing through the first surface area of the at least one magnifying lens is concentrated onto the lesser second surface area of the absorbing surface.

In an embodiment of the energy conversion system further comprising a central control unit coupled to the support structure wherein the central control unit comprises a primary power storage unit coupled to the at least one wave converter and the at least one solar converter to store the electricity, a power transformer coupled to the primary power storage unit to convert the electricity into a modified electricity having a predetermined frequency wave form, a power transfer unit coupled to the primary power storage unit and the power transformer to control output of the modified electricity, and a primary controller coupled to the primary power storage unit and in communication with the at least one wave converter and the at least one solar converter to monitor and control the at least one wave converter and the at least one solar converter.

In accordance with an aspect of the present inventive concepts, an energy conversion system comprising at least one solar converter that converts solar energy of sunlight into electricity and the solar energy of the sunlight having a solar coordinate, at least one wind converter that converts kinetic energy of wind into the electricity and the kinetic energy of the wind applies a horizontal force in a direction, at least one wave converter that converts kinetic energy of waves of a body of water into the electricity wherein the at least one wave converter comprises at least one floating assembly that at least partially floats on the body of water and the kinetic energy of the waves of the body of water applies a vertical force on the at least one floating assembly whereby moving the at least one floating assembly in response to the vertical force, at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, at least one magnetic assembly having at least one magnetic field having at least one magnetic strength coupled to the at least one rod assembly whereby coupling the at least one magnetic assembly to the at least one rod assembly moves the at least one magnetic assembly in response to the vertical force applied to the at least one floating assembly, and at least one coil assembly external to the at least one rod assembly and directly adjacent the at least one magnetic assembly and the at least one magnetic assembly moves relative to the at least one coil assembly whereby generating the electricity at the at least one coil assembly, and a support structure coupled to the at least one wave converter and the at least one wind converter and the at least one solar converter that at least supports the at least one wave converter and the at least one wind converter and the at least one solar converter at least partially above the body of water.

In an embodiment of the energy conversion system wherein the at least one coil assembly comprises at least one conductive wave coil having at least one second conductive wire coiled around at least one second conductive core and the at least one conductive wave coil moving relative to the at least one magnetic field in response to the at least one floating assembly whereby generating the electricity at the at least one conductive wave coil.

In an embodiment of the energy conversion system wherein the at least one magnetic assembly comprises at least one of at least one wave electromagnet or at least one wave permanent magnet.

In an embodiment of the energy conversion system wherein the support structure comprises at least one support leg having a top end and a bottom end and the bottom end is coupled to at least one of a ground surface or at least one support buoy and the top end extends above the body of water, and at least one platform having an upper surface and a lower surface and the at least one platform is coupled to the at least one support leg whereby supporting the at least one platform horizontally above the body of water.

In an embodiment of the energy conversion system further comprising a housing having an opening and the proximal end of the at least one rod assembly extends through the opening and the housing at least partially surrounds the at least one magnetic assembly and the at least one coil assembly.

In an embodiment of the energy conversion system further comprising at least one wave assembly controller coupled to the at least one magnetic assembly that adjusts the at least one magnetic strength of the at least one magnetic field, and at least one wave gauge in communication with the at least one wave assembly controller that measures the vertical force applied to the at least one floating assembly and the at least one wave gauge generates a vertical force signal corresponding to the vertical force and communicates the vertical force signal to the at least one wave assembly controller to adjust the at least one magnetic strength relative to the vertical force.

In an embodiment of the energy conversion system further comprising at least one rod guide having an interior surface and an exterior surface and the exterior surface is coupled to the support structure and the interior surface at least partially surrounds the at least one rod assembly.

In an embodiment of the energy conversion system wherein the at least one rod assembly further comprises at least one rod magnet having a magnetic polarity and the interior surface of the at least one rod guide further having the magnetic polarity and the magnetic polarity of the interior surface of the at least one rod guide opposes the magnetic polarity of the at least one rod magnet to form a frictionless relationship between the at least one rod assembly and the at least one rod guide.

In an embodiment of the energy conversion system wherein the at least one wind converter comprises an axel having a first axel end and a second axel end, at least one wind collector coupled to the axel that moves in response to the horizontal force whereby rotating the axel in response to the horizontal force applied to the at least one wind collector, at least one axel guide that movably supports and at least partially surrounds the axel and the axel rotates in response to the horizontal force applied to the at least one wind collector, at least one wind magnetic assembly having at least one wind magnetic field having at least one wind magnetic strength and the at least one wind magnetic assembly is coupled to the axel the at least one wind magnetic assembly moves, and at least one wind coil assembly directly adjacent and at least partially surrounding the at least one wind magnetic assembly whereby moving the at least one wind magnetic assembling relative to the at least one wind coil assembly generates the electricity at the at least one wind coil assembly.

In an embodiment of the energy conversion system wherein the at least one wind coil assembly comprises at least one conductive wind coil having at least one second conductive wind wire coiled around at least one second conductive wind core and the at least one conductive wind coil moves relative to the at least one wind magnetic field in response to the rotation of the axel whereby generating the electricity at the at least one conductive wind coil.

In an embodiment of the energy conversion system wherein the at least one wind magnetic assembly comprises at least one of at least one wind electromagnet or at least one wind permanent magnet.

In an embodiment of the energy conversion system wherein the at least one wind collector is an elongated propeller coupled to the axel and the at least one axel guide movably supports the axel horizontally whereby the axel rotates on a horizontal axis in response to the horizontal force.

In an embodiment of the energy conversion system wherein the at least one wind collector is an elongated scoop coupled to the axel and the at least one axel guide movably supports the axel vertically whereby the axel rotates on a vertical axis in response to the horizontal force.

In an embodiment of the energy conversion system wherein the at least one axle guide further comprises an interior guide surface having at least one axel guide magnet having a magnetic polarity and the axel further comprises at least one axel magnet having the magnetic polarity and the magnetic polarity of the at least one axel guide magnet opposes the magnetic polarity of the at least one axel magnet to form a frictionless relationship between the axel and the at least one axle guide.

In an embodiment of the energy conversion system further comprising a wind assembly controller in communication with the at least one wind magnetic assembly that adjusts the at least one wind magnetic strength of the at least one wind magnetic field relative to the horizontal force and that positions of the at least one wind converter relative to the direction applied by the kinetic energy of the wind, and a wind gauge that measures the direction and the horizontal force applied by the kinetic energy of the wind and the wind gauge generates a directional signal corresponding to the direction and communicates the directional signal to the wind assembly controller to adjust the position of the at least one wind converter relative to the direction and the wind gauge generates a horizontal force signal corresponding to the horizontal force and communicates the horizontal force signal to the wind assembly controller to adjust the at least one wind magnetic strength of the at least one wind magnetic assembly relative to the horizontal force.

In an embodiment of the energy conversion system further comprising a wind converter housing at least partially surrounding the at least one wind coil assembly, a support assembly coupled to the support structure to support the wind converter housing at least partially above the body of water, and a rotational device movably coupling the wind converter housing to the support assembly and in communication with the wind assembly controller to adjust the position of the at least one wind collector relative to the direction and the horizontal force.

In an embodiment of the energy conversion system wherein the at least one solar converter comprises at least one solar receptor having an absorbing surface and a non-absorbing surface and the absorbing surface collects the solar energy of the sunlight and converts the solar energy of the sunlight into the electricity.

In an embodiment of the energy conversion system further comprising at least one rotator coupled to the support structure to position the absorbing surface of the at least one solar receptor from a first coordinate to a second coordinate and the first coordinate having a first direction and a first angle and the second coordinate having a second direction and a second angle whereby moving the at least one rotator from the first coordinate to the second coordinate changes at least one of the first direction or the first angle to at least one of the second direction or the second angle, a positioning arm having a first length movably coupling the at least one rotator to the non-absorbing surface of the at least one solar receptor to move the at least one solar receptor, a controller in communication with the at least one rotator to position the absorbing surface of the at least one solar receptor and the controller signals the at least one rotator to move the positioning arm whereby moving the absorbing surface of the at least one solar receptor from the first coordinate to the second coordinate, and at least one solar gauge movably coupled to the support structure and in communication with the controller and the at least one solar gauge calculates the solar coordinate of the solar energy of the sunlight having a solar direction and a solar angle and the at least one solar gauge calculates an optimal coordinate of the absorbing surface having an optimal direction and an optimal angle and the optimal coordinate of the absorbing surface is a predetermined solar angle of the absorbing surface of the at least one solar receptor relative to the solar coordinate and the at least one solar gauge generates a positioning signal corresponding to the optimal coordinate and communicates the positioning signal to the controller whereby the controller moves the at least one solar receptor to maximize the solar energy collected by the absorbing surface.

In an embodiment of the energy conversion system comprises at least one magnifying lens having a first surface area coupled to the at least one solar receptor and fixed adjacent the absorbing surface having a second surface area and the first surface area is greater than the second surface area whereby the solar energy of the sunlight passing through the first surface area of the at least one magnifying lens is concentrated onto the lesser second surface area of the absorbing surface.

In accordance with an aspect of the present inventive concepts, an energy conversion method comprising providing at least one wave converter that converts kinetic energy of waves of a body of water into electricity wherein providing the at least one wave converter comprises providing at least one floating assembly that at least partially floats on the body of water and the kinetic energy of the waves of the body of water applies a vertical force on the at least one floating assembly whereby moving the at least one floating assembly in response to the vertical force, providing at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, providing at least one magnetic assembly having at least one magnetic field having at least one magnetic strength coupled to the at least one rod assembly whereby coupling the at least one magnetic assembly to the at least one rod assembly moves the at least one magnetic assembly in response to the vertical force applied to the at least one floating assembly, and providing at least one coil assembly external to the at least one rod assembly and directly adjacent the at least one magnetic assembly and the at least one magnetic assembly moves relative to the at least one coil assembly whereby generating the electricity at the at least one coil assembly.

In an embodiment of the energy conversion method wherein providing the at least one coil assembly comprises providing at least one conductive wave coil having at least one second conductive wire coiled around at least one second conductive core and the at least one conductive wave coil passes through the at least one magnetic field in response to the vertical force moving the at least one magnetic assembly whereby generating the electricity at the at least one conductive wave coil.

In an embodiment of the energy conversion method wherein providing the at least one magnetic assembly comprises providing at least one of at least one wave electromagnet or at least one wave permanent magnet.

In an embodiment of the energy conversion method further comprising providing a support structure coupled to the at least one wave converter that supports the at least one wave converter at least partially above the body of water.

In an embodiment of the energy conversion method further comprising providing at least one wave assembly controller coupled to the at least one magnetic assembly that adjusts the at least one magnetic strength of the at least one magnetic field, and providing at least one wave gauge in communication with the at least one wave assembly controller that measures the vertical force applied to the at least one floating assembly and the at least one wave gauge generates a vertical force signal corresponding to the vertical force and communicates the vertical force signal to the at least one wave assembly controller to adjust the at least one magnetic strength relative to the vertical force.

In an embodiment of the energy conversion method further comprising providing at least one current inverter in communication with the at least one coil assembly and the electricity generated at the at least one coil assembly moves in a first direction when the at least one magnetic assembly moves in an upward direction from a first position relative to the at least one coil assembly to a second position higher than the first position in response to the at least one floating assembly moving in the upward direction and the electricity generated at the at least one coil assembly moves in a second direction when the at least one magnetic assembly moves in a downward direction from a third position relative to the at least one coil assembly to a fourth position lower than the third position in response to the at least one floating assembly moving in the downward direction and the at least one current inverter converts the electricity moving in the second direction into the electricity moving in the first direction whereby all the electricity generated by the at least one magnetic assembly moving in the upward direction and in the downward direction is the electricity moving in the first direction.

In an embodiment of the energy conversion method further comprising providing at least one rod guide having an interior surface and an exterior surface and the exterior surface is coupled to the support structure and the interior surface at least partially surrounds the at least one rod assembly.

In accordance with an aspect of the present inventive concepts, an energy conversion method comprising providing at least one wave converter that converts kinetic energy of waves of a body of water into the electricity wherein providing the at least one wave converter comprises providing at least one floating assembly that at least partially floats on the body of water and the kinetic energy of the waves of the body of water applies a vertical force on the at least one floating assembly whereby moving the at least one floating assembly in response to the vertical force, providing at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, providing at least one magnetic assembly having at least one magnetic field having at least one magnetic strength coupled to the at least one rod assembly whereby coupling the at least one magnetic assembly to the at least one rod assembly moves the at least one magnetic assembly in response to the vertical force applied to the at least one floating assembly, and providing at least one coil assembly external to the at least one rod assembly and directly adjacent the at least one magnetic assembly and the at least one magnetic assembly moves relative to the at least one coil assembly whereby generating the electricity at the at least one coil assembly, providing at least one wind converter that converts kinetic energy of wind into electricity and the kinetic energy of the wind applies a horizontal force in a direction wherein providing the at least one wind converter comprises providing an axel having a first axel end and a second axel end, providing at least one wind collector coupled to the axel that moves in response to the horizontal force whereby rotating the axel in response to the horizontal force applied to the at least one wind collector, providing at least one axel guide that movably supports and at least partially surrounds the axel and the axel rotates in response to the horizontal force applied to the at least one wind collector, providing at least one wind magnetic assembly having at least one wind magnetic field having at least one wind magnetic strength and the at least one wind magnetic assembly is coupled to the axel the at least one wind magnetic assembly moves, and providing at least one wind coil assembly directly adjacent and at least partially surrounding the at least one wind magnetic assembly whereby moving the at least one wind magnetic assembling relative to the at least one wind coil assembly generates the electricity at the at least one wind coil assembly, and providing a support structure coupled to the at least one wave converter and the at least one wind converter that supports the at least one wave converter and the at least one wind converter at least partially above the body of water.

In accordance with an aspect of the present inventive concepts, an energy conversion method comprising providing at least one wave converter that converts kinetic energy of waves of a body of water into the electricity wherein providing the at least one wave converter comprises providing at least one floating assembly that at least partially floats on the body of water and the kinetic energy of the waves of the body of water applies a vertical force on the at least one floating assembly whereby moving the at least one floating assembly in response to the vertical force, providing at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, providing at least one magnetic assembly having at least one magnetic field having at least one magnetic strength and coupled to the at least one rod assembly whereby coupling the at least one magnetic assembly to the at least one rod assembly moves the at least one magnetic assembly in response to the vertical force applied to the at least one floating assembly, and providing at least one coil assembly external to the at least one rod assembly and directly adjacent the at least one magnetic assembly and the at least one magnetic assembly moves relative to the at least one coil assembly whereby generating the electricity at the at least one coil assembly, providing at least one solar converter that converts solar energy of sunlight into electricity wherein providing the at least one solar converter comprises providing at least one solar receptor having an absorbing surface and a non-absorbing surface and the absorbing surface collects the solar energy of the sunlight and converts the solar energy of the sunlight into the electricity, and providing a support structure coupled to the at least one wave converter and the at least one solar converter that supports the at least one wave converter and the at least one solar converter at least partially above the body of water.

In accordance with an aspect of the present inventive concepts, an energy conversion method comprising providing at least one wave converter that converts kinetic energy of waves of a body of water into electricity wherein providing the at least one wave converter comprises providing at least one floating assembly that at least partially floats on the body of water and the kinetic energy of the waves of the body of water applies a vertical force on the at least one floating assembly whereby moving the at least one floating assembly in response to the vertical force, providing at least one rod assembly having a proximal end and a distal end and the distal end is coupled to the at least one floating assembly whereby coupling the distal end to the at least one floating assembly moves the at least one rod assembly in response to the vertical force applied to the at least one floating assembly, providing at least one magnetic assembly having at least one magnetic field having at least one magnetic strength coupled to the at least one rod assembly whereby coupling the at least one magnetic assembly to the at least one rod assembly moves the at least one magnetic assembly in response to the vertical force applied to the at least one floating assembly, and providing at least one coil assembly external to the at least one rod assembly and directly adjacent the at least one magnetic assembly and the at least one magnetic assembly moves relative to the at least one coil assembly whereby generating the electricity at the at least one coil assembly, providing at least one wind converter that converts kinetic energy of wind into electricity and the kinetic energy of the wind applies a horizontal force in a direction wherein providing the at least one wind converter comprises providing an axel having a first axel end and a second axel end, providing at least one wind collector coupled to the axel that moves in response to the horizontal force whereby rotating the axel in response to the horizontal force applied to the at least one wind collector, providing at least one axel guide that movably supports and at least partially surrounds the axel whereby rotating the axel in response to the horizontal force applied to the at least one wind collector, providing at least one wind magnetic assembly having at least one wind magnetic field having at least one wind magnetic strength and the at least one wind magnetic assembly is coupled to the axel the at least one wind magnetic assembly moves, and providing at least one wind coil assembly directly adjacent and at least partially surrounding the at least one wind magnetic assembly whereby moving the at least one wind magnetic assembling relative to the at least one wind coil assembly generates the electricity at the at least one wind coil assembly, providing at least one solar converter that converts solar energy of sunlight into electricity wherein providing the at least one solar converter comprises providing at least one solar receptor having an absorbing surface and a non-absorbing surface the absorbing surface collects the solar energy of the sunlight and converts the solar energy of the sunlight into the electricity, and providing a support structure coupled to the at least one wave converter and the at least one wind converter and the at least one solar converter that at least supports the at least one wave converter and the at least one wind converter and the at least one solar converter at least partially above the body of water.

### BRIEF DESCRIPTION OF THE DRAWINGS

The foregoing and other objects, features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a perspective view of an embodiment of an energy conversion system showing at least one wave converter, in accordance with aspects of the present inventive concepts;

FIG. 2 is a perspective view of an embodiment of the wave converter of FIG. 1 further comprising a housing, in accordance with aspects of the present inventive concepts;

FIG. 3 is a perspective view of an embodiment of the wave converter of FIG. 2, showing at least one magnetic assembly and at least one coil assembly, in accordance with aspects of the present inventive concepts;

FIG. 4 is a perspective view of an embodiment of the magnetic assembly of FIG. 2 and FIG. 3, in accordance with aspects of the present inventive concepts;

FIG. 5 is a perspective view of an embodiment of at least one wave converter, wherein at least one magnetic assembly is in communication with at least one wave assembly controller and at least one wave gauge, in accordance with aspects of the present inventive concepts;

FIG. 6 is a perspective view of an embodiment of at least one wave converter, wherein at least one magnetic assembly includes at least one electromagnet that is coupled to at least one power source that is coupled to at least one charger, and wherein at least one coil assembly includes at least one wave coil magnet coupled to a coil assembly power storage unit, in accordance with aspects of the present inventive concepts;

FIG. 7 is a cutaway perspective view of an embodiment of at least one rod guide at least partially surrounding at least one rod assembly, in accordance with aspects of the present inventive concepts;

FIG. 8 is a cutaway perspective view of an embodiment of at least one rod guide having a magnetic polarity, and at least one rod assembly comprising at least one rod magnet having the magnetic polarity, in accordance with aspects of the present inventive concepts;

FIG. 9 is a perspective view of an embodiment of at least one coil assembly coupled to at least one current converter, and illustrating the operation of the current inverter with regard to movement of at least one magnetic assembly relative to the coil assembly, in accordance with aspects of the present inventive concepts;

FIG. 10 is a perspective view of an embodiment of an energy conversion system, showing at least one wave converter coupled to a support structure that supports the wave converter and a central control unit at least partially above a body of water, in accordance with aspects of the present inventive concepts;

FIG. 11 is a perspective view of an embodiment of the support structure shown in FIG. 10, wherein at least one support leg couples at least one support buoy to at least one platform, whereby supporting the platform above the body of water, in accordance with aspects of the present inventive concepts;

FIG. 12 is a perspective view of an embodiment of the structure in FIG. 10, showing the wherein at least one support leg couples at least one support buoy to at least one platform, wherein the support buoy is coupled the a ground under the surface of the body of water, in accordance with aspects of the present inventive concepts;

FIG. 13 is a perspective view of an embodiment of an energy conversion system, showing at least one of at least one wave converter and/or at least one wind converter coupled to a support structure that supports the wave converter and/or the wind converter and/or a central control unit at least partially above a body of water, in accordance with aspects of the present inventive concepts;

FIG. 14 is a perspective view of an embodiment of at least one wind converter comprising at least one wind collector wherein the wind collector is at least one elongated propeller coupled to an axel that is oriented horizontally, in accordance with aspects of the present inventive concepts;

FIG. 15 is a perspective view of an embodiment of at least one wind converter comprising at least one wind collector wherein the wind collector is at least one elongated scoop coupled to an axel that is oriented vertically, in accordance with aspects of the present inventive concepts;

FIG. 16 is a cutaway perspective view of an embodiment of at least one axel guide that at least partially surrounds an axel, in accordance with aspects of the present inventive concepts;

FIG. 17 is a cutaway perspective view of an embodiment of at least one axel guide, having a magnetic polarity, that at least partially surrounds an axel comprising at least one axel magnet, in accordance with aspects of the present inventive concepts;

FIG. 18 is a perspective view of an embodiment of at least one wind magnetic assembly and at least one wind coil assembly, in accordance with aspects of the present inventive concepts;

FIG. 19 is a perspective view of an embodiment of at least one wind magnetic assembly and at least one wind coil assembly, in accordance with aspects of the present inventive concepts;

FIG. 20 is a perspective view of an embodiment of an energy conversion system, showing at least one of at least one wave converter and/or at least one solar converter coupled to a support structure that supports the wave converter and/or the solar converter and/or a central control unit at least partially above a body of water, in accordance with aspects of the present inventive concepts;

FIG. 21 is a perspective view of an embodiment of at least one solar converter supported above a body of water, in accordance with aspects of the present inventive concepts;

FIG. 22 is a perspective view of an embodiment of at least one solar converter illustrating the directional repositioning of an absorbing surface of the solar converter, in accordance with aspects of the present inventive concepts;

FIG. 23 is a perspective view of an embodiment of at least one solar converter illustrating the vertical repositioning of an absorbing surface of the solar converter, in accordance with aspects of the present inventive concepts;

FIG. 24 is a perspective view of an embodiment of at least one solar converter further comprising at least one magnifying lens coupled to the solar converter, in accordance with aspects of the present inventive concepts; and

FIG. 25 is a perspective view of an embodiment of an energy conversion system, showing at least one of at least one wave converter and/or at least one wind converter and/or at least one solar converter coupled to a support structure supporting the wave converter and/or the wind converter and/or the solar converter and/or a central control unit at least partially above a body of water, in accordance with aspects of the present inventive concepts.

### DETAILED DESCRIPTION OF THE EMBODIMENTS

The accompanying drawings are described below, in which example embodiments in accordance with the present inventive concepts are shown. Specific structural and functional details disclosed herein are merely representative. This invention may be embodied in many alternate forms and should not be construed as limited to example embodiments set forth herein.

Accordingly, specific embodiments are shown by way of example in the drawings. It should be understood, however, that there is no intent to limit the invention to the particular forms disclosed, but on the contrary, the invention is to cover all modifications, equivalents, and alternatives falling within the spirit and scope of the claims.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present inventive concepts. As used herein, the term “and/or” includes any and all combinations of one or more of the associated listed items.

It will be understood that when an element is referred to as being “on,” “connected to” “abutting,” “coupled to,” or “extending from” another element, it can be directly on, connected to, abutting, or coupled to the other element or intervening elements may be present. In contrast, when an element is referred to as being “directly on,” “directly connected to,” “directly abutting,” “directly coupled to,” or “directly extending from” another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In order to overcome the limitations described above with regard to converting kinetic energy of waves of a body of water into electricity, and/or converting kinetic energy of wind into the electricity, and/or converting solar energy of sunlight into the electricity, systems and methods in accordance with embodiments herein are provided that generate a maximum amount of the electricity, regardless of the properties of the body of water, wind properties, or solar properties.

To achieve the maximization of electricity generated from the kinetic energy of the body of water, certain systems and methods in accordance with the embodiments include one or more energy conversion systems that each comprises at least one wave converter. The wave converter comprises at least one floating assembly that transfers a vertical force applied by the kinetic energy of the body of water to at least one magnetic assembly coupled to the floating assembly by at least one rod assembly, whereby moving the magnetic assembly in response to the vertical force. The magnetic assembly utilizes at least one wave electromagnet and/or at least one wave permanent magnet to produce at least one magnetic field having at least one magnetic strength. The wave converter further comprises at least one coil assembly wherein at least one conductive wave coil further comprises at least one second conductive wire wrapped around at least one second conductive core. The conductive wave coils are separated by at an insulating material, are coupled together and configured into the coil assemblies that generate electricity when movement occurs between the coil assemblies and the magnetic field produced by the wave electromagnet and/or the wave permanent magnet. The magnetic strength of the magnetic assembly can be controlled by at least one wave assembly controller in response to the vertical force. During operation, when the vertical force is applied to the floating assembly, the magnetic assembly moves relative to the coil assemblies. The wave assembly controller can receive information related to waves proximal to the floating assembly, which at least partially floats on the body of water, and in response to this information, can change the magnetic strength of the magnetic field of the magnetic assembly, therefore increasing the amount of the electricity generated at the conductive wave coils. Thus, regardless of the direction of movement of the magnetic assembly relative to the coil assembly, and regardless of the vertical force applied to the floating assembly by the kinetic energy of the body of water, the energy conversion system can generate a maximum amount of electricity relative to the vertical force.

To achieve the maximization of the electricity generated from the kinetic energy of the wind, certain systems and methods in accordance with the embodiments include one or more energy conversion systems that may each comprise at least one wind converter. The wind converter comprises at least one wind collector, coupled to an axel, that converts a horizontal force, applied to the wind collector by the kinetic energy of the wind, into a rotational force applied to the axel, whereby rotating at least one wind magnetic assembly, coupled to the axel, in response to the horizontal force. The wind magnetic assembly utilizes at least one wind electromagnet and/or at least one wind permanent magnet to produce at least one wind magnetic field having at least one wind magnetic strength. The wind converter further comprises at least one wind coil assembly wherein at least one conductive wind coil further comprises at least one second conductive wind wire wrapped around at least one second conductive wind core. The conductive wind coils are separated by at an insulating material and are coupled together. The electricity is generated at the conductive wind coil of the wind coil assembly when movement occurs between the wind coil assembly and the wind magnetic field produced by the wind electromagnet and/or the wind permanent magnet. The wind magnetic strength of the wind magnetic assembly can be controlled by a wind assembly controller in response to the horizontal force. During operation, when the kinetic energy of the wind applies a horizontal force, in a direction, to the wind collector, the wind magnetic assembly moves relative to the wind coil assemblies. The wind assembly controller can receive information related to the direction and the horizontal force, and in response to this information, can change the wind magnetic strength of the wind magnetic field of the wind magnetic assembly and the position of the wind collector relative to the direction, therefore increasing the amount of the electricity generated at the conductive wind coils. Thus, regardless of the direction and horizontal force applied to the wind collector by the kinetic energy of the wind, the energy conversion system can generate a maximum amount of electricity relative to the horizontal force.

To achieve the maximization of the electricity generated from the solar energy of the sunlight, certain systems and methods in accordance with the embodiments include one or more energy conversion systems that may each comprise at least one solar converter. The solar converter comprises at least one solar receptor that converts the solar energy of the sunlight into electricity through the use of at least one photoelectric cell included in an absorbing surface of the solar receptor. Photoelectric cells are commonly used in the conversion of solar energy into electricity and are known to one of ordinary skill in the art. Positioning of the absorbing surface of the solar receptor can be controlled by at least one solar gauge in communication with at least one rotator. At least one positioning arm movably couples the solar receptor to the rotator enabling the rotator to move the positioning arm, whereby moving the solar receptor. During operation, the solar gauge calculates a solar coordinate of the solar energy of the sunlight that defines the position of the sunlight relative to the solar receptor. The solar gauge periodically calculates an optimal coordinate that maximizes the exposure of the absorbing surface of the solar receptor to the solar energy of the sunlight. The solar gauge also periodically generates a positioning signal corresponding to the optimal coordinate and communicates the positioning signal to the controller whereby instructing the rotator to move the solar receptor to the optimal coordinate. Moving the absorbing surface to the optimal coordinate maximizes the solar energy of the sunlight collected by the absorbing surface at any given time, whereby maximizing the electricity generated by the solar receptor relative to the solar energy of the sunlight.

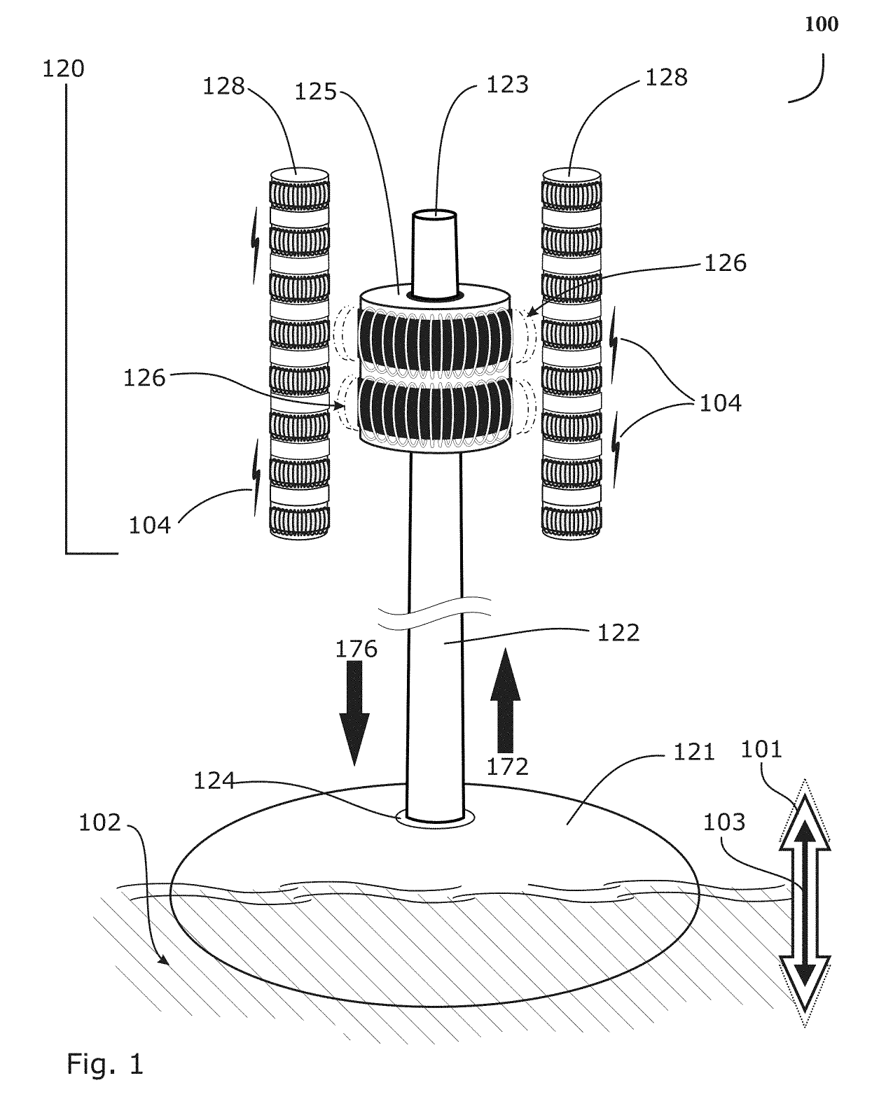

FIG. 1 shows a perspective view of an embodiment of an energy conversion system 100 in accordance with aspects of the present inventive concepts.

In an embodiment, the energy conversion system 100 comprises at least one wave converter 120 that converts kinetic energy of waves 101 of a body of water 102 into electricity 104.

The wave converter 120 comprises at least one floating assembly 121, at least one rod assembly 122 having a proximal end 123 and a distal end 124, at least one magnetic assembly 125 having at least one magnetic field 126 having at least one magnetic strength 127, and at least one coil assembly 128.

The floating assembly 121 is buoyant and at least partially floats on the body of water 102. The floating assembly 121 comprises materials known to those of ordinary skill in the art, for example, fiberglass, foams, plastics, metals, metal alloys, or composites, that permit the floating assembly 121 to be at least partially buoyant and to be responsive to the movement of the body of water 102. The kinetic energy of the waves 101 of the body of water 102 applies a vertical force 103 to the floating assembly 121, whereby moving the floating assembly 121 in an upward direction 172 and a downward direction 176. The floating assembly 121 is coupled to the distal end 124 of the rod assembly 122, whereby moving the rod assembly 122 in response to the vertical force 103 applied to the floating assembly 121. The magnetic assembly 125 is coupled to the rod assembly 122 and moves in response to the movement of the rod assembly 122. The coil assembly 128, adjacent and at least partially surrounding the magnetic assembly 125, moves relative to the magnetic assembly 125 in response to the vertical force 103 applied to the floating assembly 121. The magnetic field 126 of the magnetic assembly 125 moves relative to the coil assembly 128 in response to the movement of the magnetic assembly 125, whereby generating the electricity 104 at the coil assembly 128.

In an embodiment, the amount of the electricity generated depends on the force, height, speed, etc. of the wave, and/or the strength of the magnetic field 126 of the magnetic assembly 125.

In an embodiment, the rod assembly 122 is formed from a single uniform material.

In an embodiment, the rod assembly 122 is formed from multiple materials or components.

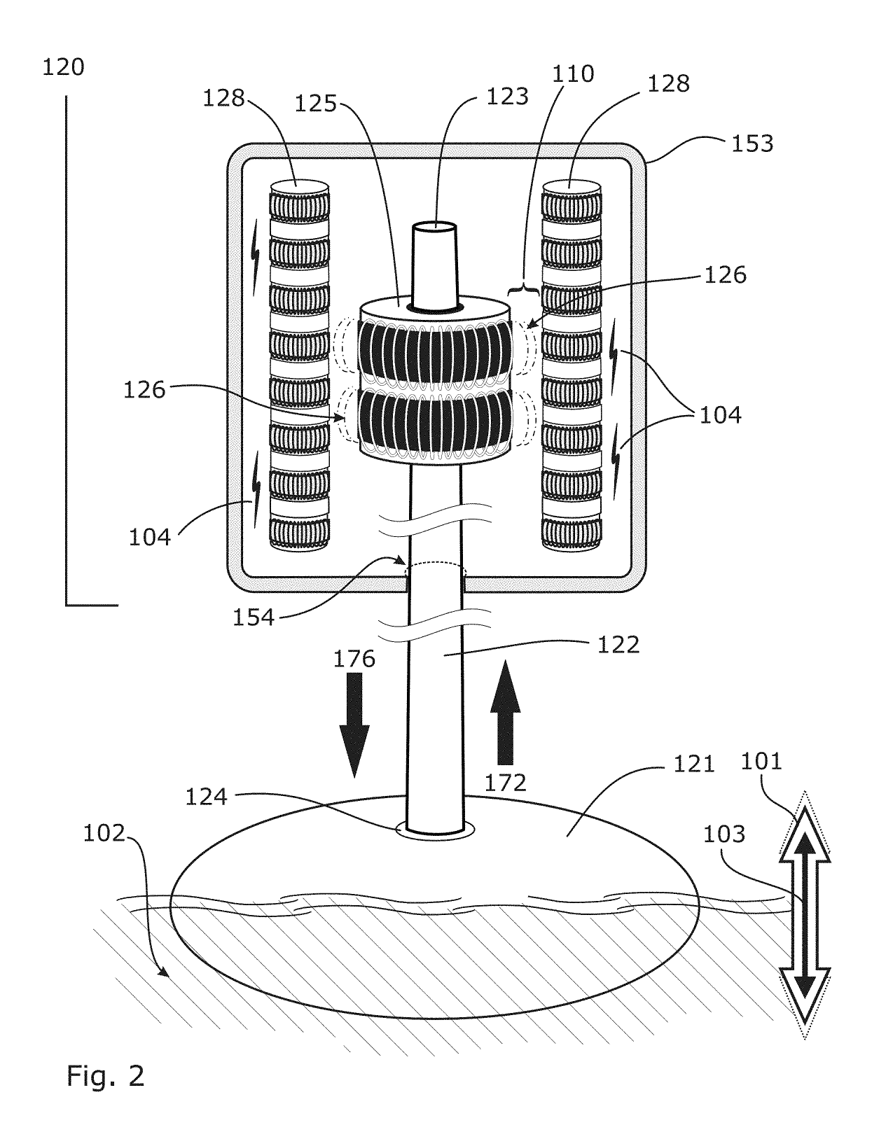

FIG. 2 shows a perspective view of an embodiment of the wave converter 120 wherein the wave converter further comprises a housing 153 having an opening 154 where the proximal end 123 of the rod assembly 122 extends through the opening 154 of the housing 153. The housing 153 at least partially surrounds the coil assembly 128, and the coil assembly 128 is adjacent and at least partially surrounds the magnetic assembly 125 providing a distance 110 between the coil assembly 128 and the magnetic assembly 125. The magnetic assembly 125 is coupled to the rod assembly 122 that extends through the opening 154, whereby enabling the magnetic assembly 125 to move in the upward direction 172 and downward direction 176 within the housing 153 in response to the movement of the rod assembly 122. The housing 153 provides shielding from external elements, such as water, by at least partially surrounding the coil assembly 128 and the magnetic assembly 125, and the housing 153 obviates the need for shielding between the coil assembly 128 and the magnetic assembly 125 whereby minimizing the distance 110 between the coil assembly 128 and the magnetic assembly 125. The electricity 104 generated at the coil assembly 128, as the coil assembly 128 moves relative to the magnetic field 126 in response to the vertical force 103 applied to the floating assembly 121 by the kinetic energy of the waves 101 of the body of water 102, is inversely proportional to the distance 110. Increasing the distance 110 decreases the electricity 104 generated at the coil assembly 128, and decreasing the distance 110 increases the electricity 104 generated at the coil assembly 128. By obviating the need for shielding between the coil assembly 128 and the magnetic assembly 125, the housing 153 minimizes the distance 110 between the coil assembly 128 and the magnetic assembly 125, whereby maximizing the electricity 104 generated at the coil assembly 128.

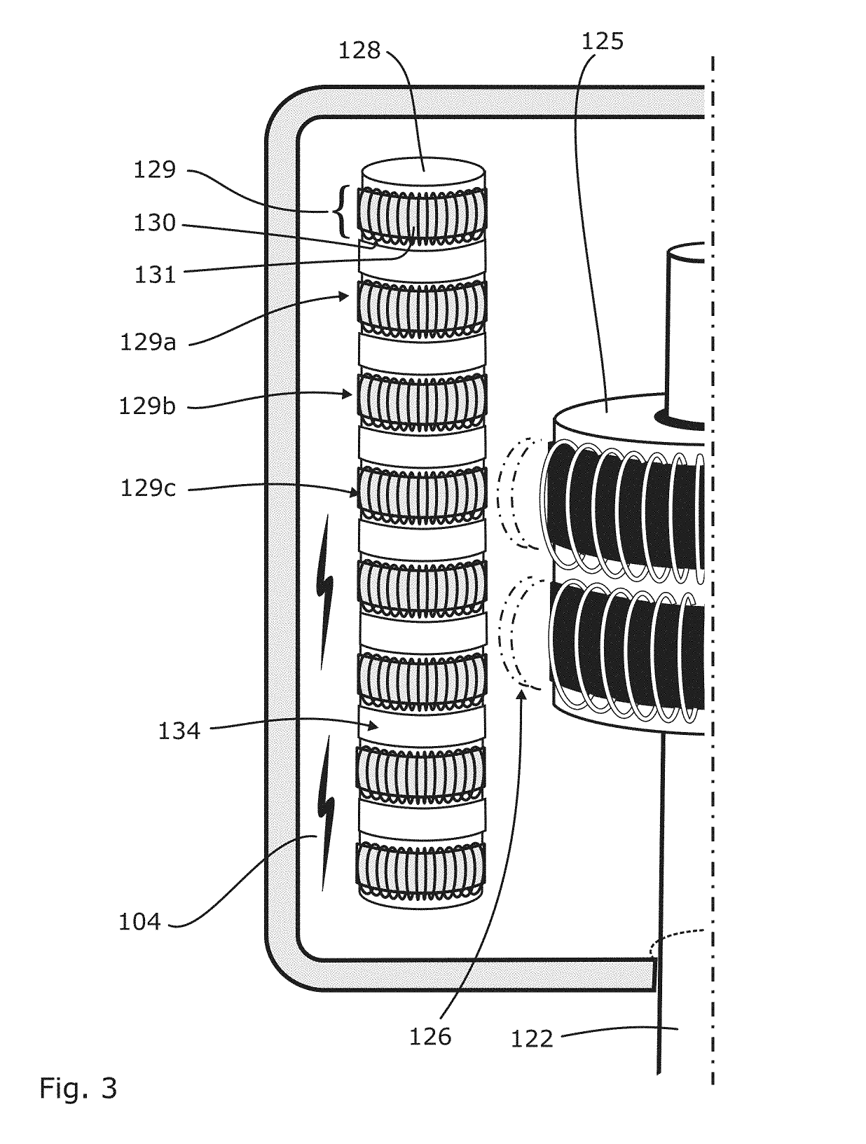

FIG. 3 shows a perspective view of an embodiment of the coil assembly 128. The coil assembly 128 comprises at least one conductive wave coil 129. The conductive wave coil 129 comprises at least one second conductive wire 130 coiled around at least one second conductive core 131, wherein the second conductive core 131 promotes the generation of the electricity 104 at the second conductive wire 130. As the magnetic assembly 125 moves in response to the movement of the rod assembly 122, the conductive wave coil 129 moves through the magnetic field 126 of the magnetic assembly 125 and generates the electricity 104 at the second conductive wire 130 of the coil assembly 128. The coil assembly 128 may comprise a plurality of conductive wave coils 129a, 129b, 129c, wherein the conductive wave coils 129a, 129b, 129c are separated by an insulating material 134, and the electricity 104 is generated independently at each of the conductive wave coils 129a, 129b, 129c as each of the conductive wave coils 129a, 129b, 129c passes through the magnetic field 126. The magnetic assembly 125 is coupled to the rod assembly 122, whereby moving the magnetic assembly 125 in response to movement of the rod assembly 122. Moving the conductive wave coils 129a, 129b, 129c through the magnetic field 126 in response to the rod assembly 122 generates the electricity 104 at the respective conductive wave coils 129a, 129b, 129c.

In an embodiment, the insulating material 134 may be an electrically nonconductive material, such as plastic, rubber, etc., known to one of ordinary skill in the art.

In an embodiment, the conductive wave coil 129 may be constructed and arranged to have different configurations known to one of ordinary skill in the art to promote efficacy of the generation of the electricity 104 at the second conductive wire as the conductive wave coil 129 passes through the magnetic field 126.

In an embodiment, the second conductive wire 130 may be formed of an electrically conductive material or blend of materials, such as copper, aluminum, etc., known to one of ordinary skill in the art to promote efficacy of the generation of the electricity 104 at the second conductive wire as the conductive wave coil 129 passes through the magnetic field 126.

In an embodiment, the second conductive wire 130 may have different shapes, such as flattened, spring-shaped, hexagonal, etc., known to one of ordinary skill in the art to promote efficacy of the generation of the electricity 104 at the second conductive wire as the conductive wave coil 129 passes through the magnetic field 126.

In an embodiment, the second conductive core 131 may be formed of a material or blend of materials known to one of ordinary skill in the art to promote efficacy of the generation of the electricity 104 at the second conductive wire as the conductive wave coil 129 passes through the magnetic field 126.

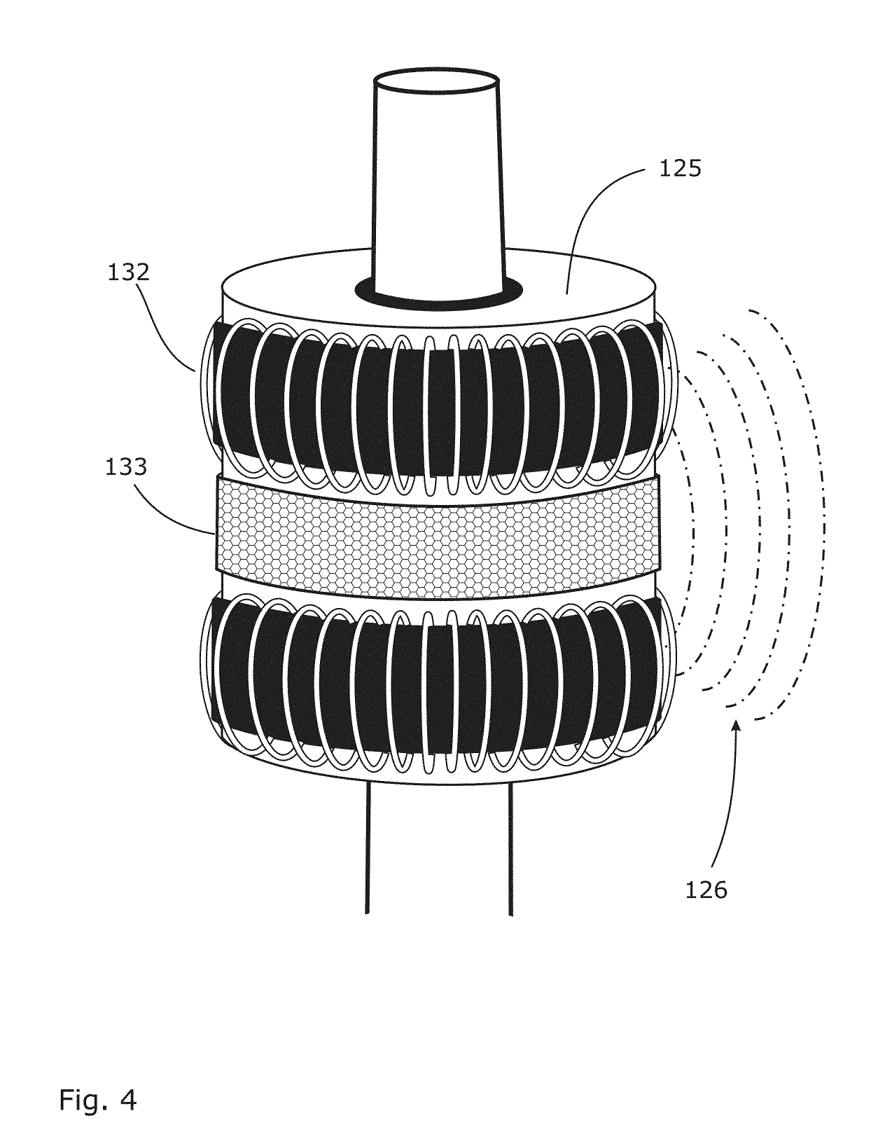

FIG. 4 shows a perspective view of an embodiment of the magnetic assembly 125. The magnetic assembly 125 comprises at least one of at least one wave electromagnet 132 or at least one wave permanent magnet 133 wherein the magnetic field 126 is generated by the wave electromagnet 132 and/or the wave permanent magnet 133. The wave electromagnet 132 enables the magnetic strength 127 of the magnetic field 126 to be adjusted. The wave permanent magnet 133 generates the magnetic field 126 even when the wave electromagnet 132 is not powered. This enables the magnetic assembly 125 to generate the electricity 104 at the coil assembly 128 without the wave electromagnet 132 being powered.

In other embodiments, the wave electromagnet 132 can be constructed and arranged to have different configurations, known to one of ordinary skill in the art, to produce the magnetic field 126.

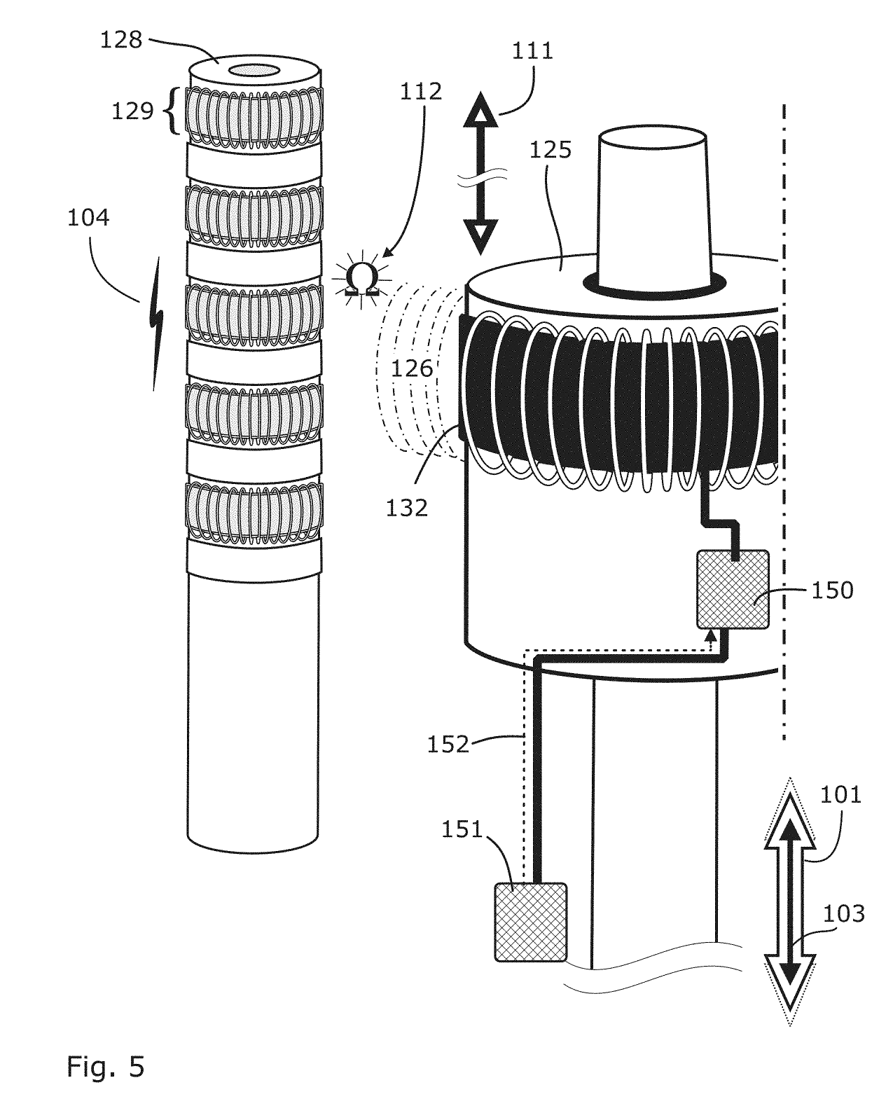

FIG. 5 shows a perspective view of another embodiment of the magnetic assembly 125 wherein the magnetic assembly 125 further comprises at least one wave assembly controller 150 and at least one wave gauge 151. The wave assembly controller 150 is coupled to the wave electromagnet 132 of the magnetic assembly 125 to adjust the power to the wave electromagnet 132, whereby adjusting the magnetic strength 127 of the magnetic field 126. The wave gauge 151 measures the vertical force 103 applied by the kinetic energy of the waves 101, and generates a vertical force signal 152 corresponding to the vertical force 103. The wave gauge 151 is in communication with the wave assembly controller 150, and communicates the vertical force signal 152 to the wave assembly controller 150 to adjust the magnetic strength 127 relative to the vertical force 103. Adjusting the magnetic strength 127 relative to the vertical force 103 in response to the magnetic field 126 moving relative to the coil assembly 128 maximizes the electricity 104 generated at the conductive wave coil 129.

The movement of the magnetic field 126 relative to the coil assembly 128 generates the electricity 104 generated at the conductive wave coil 129, and also produces a load resistance 112 between the magnetic assembly 125 and the coil assembly 128. The load resistance 112 impedes the movement of the magnetic assembly 125 and is proportional to the magnetic strength 127 of the magnetic field 126. The coil assembly 128 moves relative to the magnetic field 126 of the magnetic assembly 125 with a velocity 111, relative to the coil assembly 128, in response to the vertical force 103. The amount of the electricity 104 generated at the coil assembly 128 is relative to the velocity 111, therefore increasing the velocity 111 increases the amount of the electricity 104 generated. The electricity 104 generated at the coil assembly 128 is also relative to the magnetic strength 127 of the magnetic field 126, therefore increasing the magnetic strength 127 increases the amount of the electricity 104 generated, but also increases the load resistance 112 whereby decreasing the velocity 111.

The wave assembly controller 150 adjusts the magnetic strength 127 of the magnetic field 126 in response to changes in the vertical force 103. The wave assembly controller 150 maximizes the amount of the electricity 104 generated at the coil assembly 128 by increasing or decreasing the magnetic strength 127 of the magnetic field 126 in response to increases or decreases in the vertical force 103, whereby adjusting the load resistance 112 to optimize the velocity 111 of the coil assembly 128 passing through the magnetic field 126. Increasing the magnetic strength 127 in response to increases in the vertical force 103 increases the electricity 104 generated at the conductive wave coil 129 of the coil assembly 128. The wave assembly controller 150 maximizes the electricity 104 generated at the coil assembly 128 by adjusting the magnetic strength 127 whereby changing the load resistance 112 relative to the vertical force 103 to optimize the velocity 111 of the magnetic assembly 125 moving relative to the coil assembly 128.

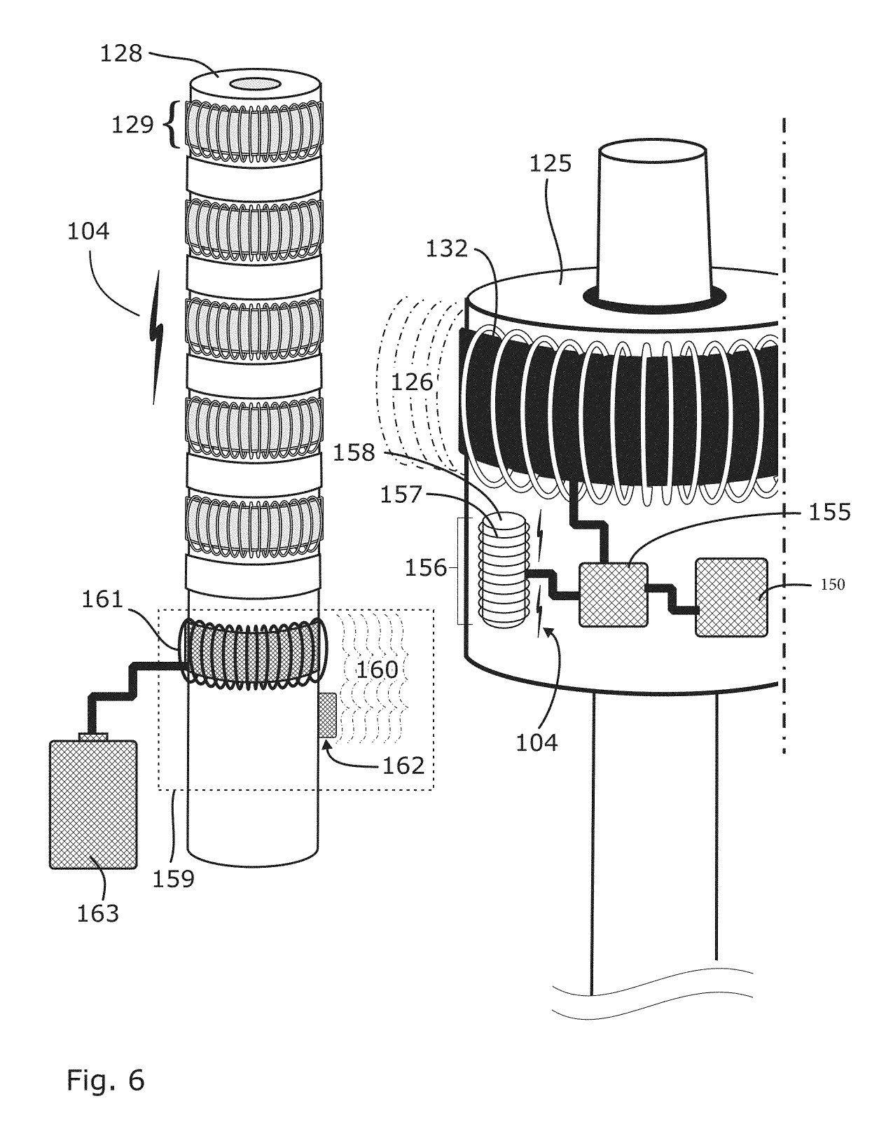

FIG. 6 shows a perspective view of another embodiment of the magnetic assembly 125 wherein the magnetic assembly 125 further comprises at least one power source 155 and at least one charger 156. The power source 155 is coupled to the wave electromagnet 132 of the magnetic assembly 125 to power the wave electromagnet 132. The charger 156, having at least one first conductive wire 157 coiled around at least one first conductive core 158, is coupled to the power source 155 to generate the electricity 104 for charging the power source 155.

In an embodiment, the coil assembly 128 comprises at least one wave coil magnet 159. The wave coil magnet 159 comprises at least one of at least one coil electromagnet 161 or at least one coil permanent magnet 162, wherein the coil electromagnet 161 and/or the coil permanent magnet 162 produces at least one coil magnetic field 160. The coil permanent magnet 162 generates the coil magnetic field 160 even when the coil electromagnet 161 is not powered. This enables the wave coil magnet 159 to generate the electricity 104 at the first conductive wire 157 of the charger 156 without the coil electromagnet 161 being powered. As the magnetic assembly 125 moves in response to the rod assembly 122, the coil magnetic field 160 moves relative to the charger 156 whereby generating the electricity 104 at the first conductive wire 157 of the charger 156. The electricity 104 generated in the charger 156 charges the power source 155 to power the wave electromagnet 132, whereby at least partially producing the magnetic field 126. The electricity 104 is generated at the conductive wave coil 129 in response to the magnetic field 126 moving relative to the conductive wave coil 129. A coil assembly power storage unit 163 is coupled to the coil assembly 128 to store the electricity 104 generated at the conductive wave coil 129 and to power the coil electromagnet 161.

In an embodiment, the first conductive wire 157 may be constructed and arranged to have different configurations known to one of ordinary skill in the art to promote efficacy of the generation of the electricity 104 at the first conductive wire 157.

In an embodiment, the first conductive wire 157 may be formed of an electrically conductive material or blend of materials, such as copper, aluminum, etc., known to one of ordinary skill in the art to promote efficacy of the generation of the electricity 104 at the first conductive wire 157.

In an embodiment, the first conductive wire 157 may have different shapes, such as flattened, spring-shaped, hexagonal, etc., known to one of ordinary skill in the art to promote efficacy of the generation of the electricity 104 at the first conductive wire 157.

In an embodiment, the first conductive core 158 may be formed of a material or blend of materials known to one of ordinary skill in the art to promote efficacy of the generation of the electricity 104 at the first conductive wire 157.

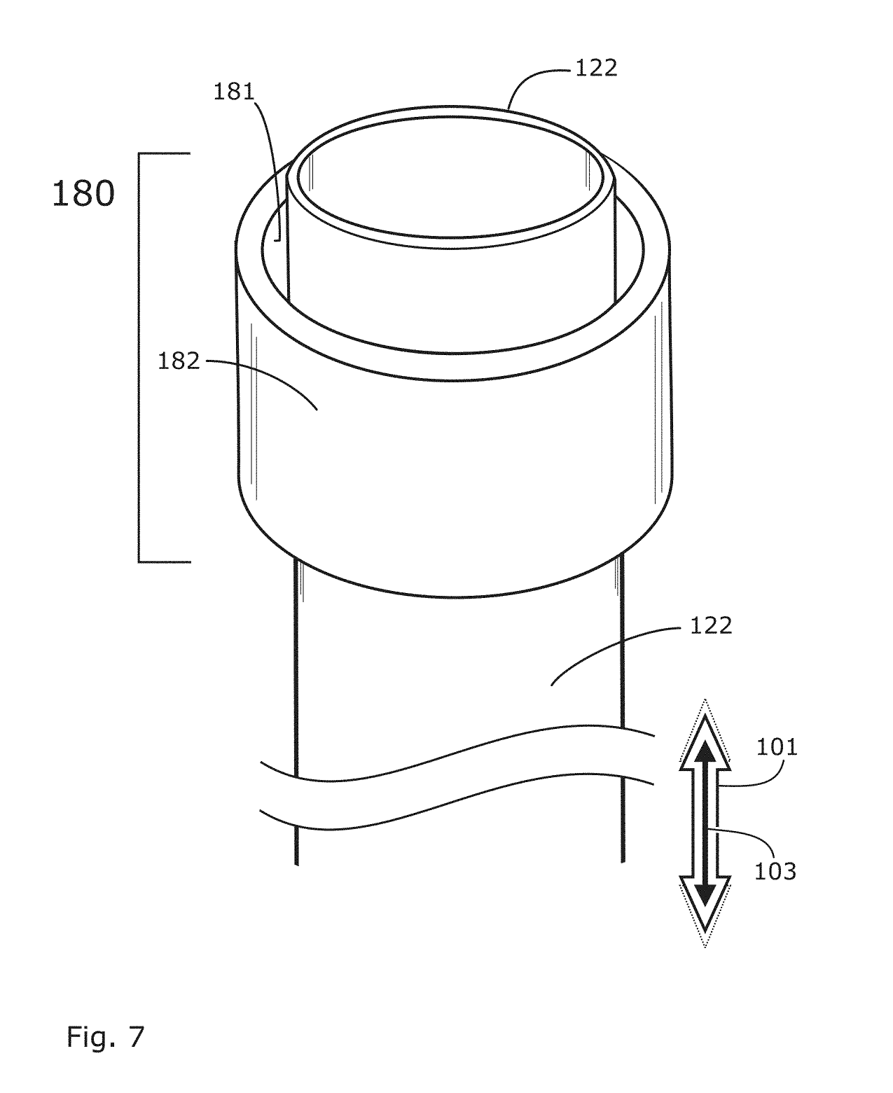

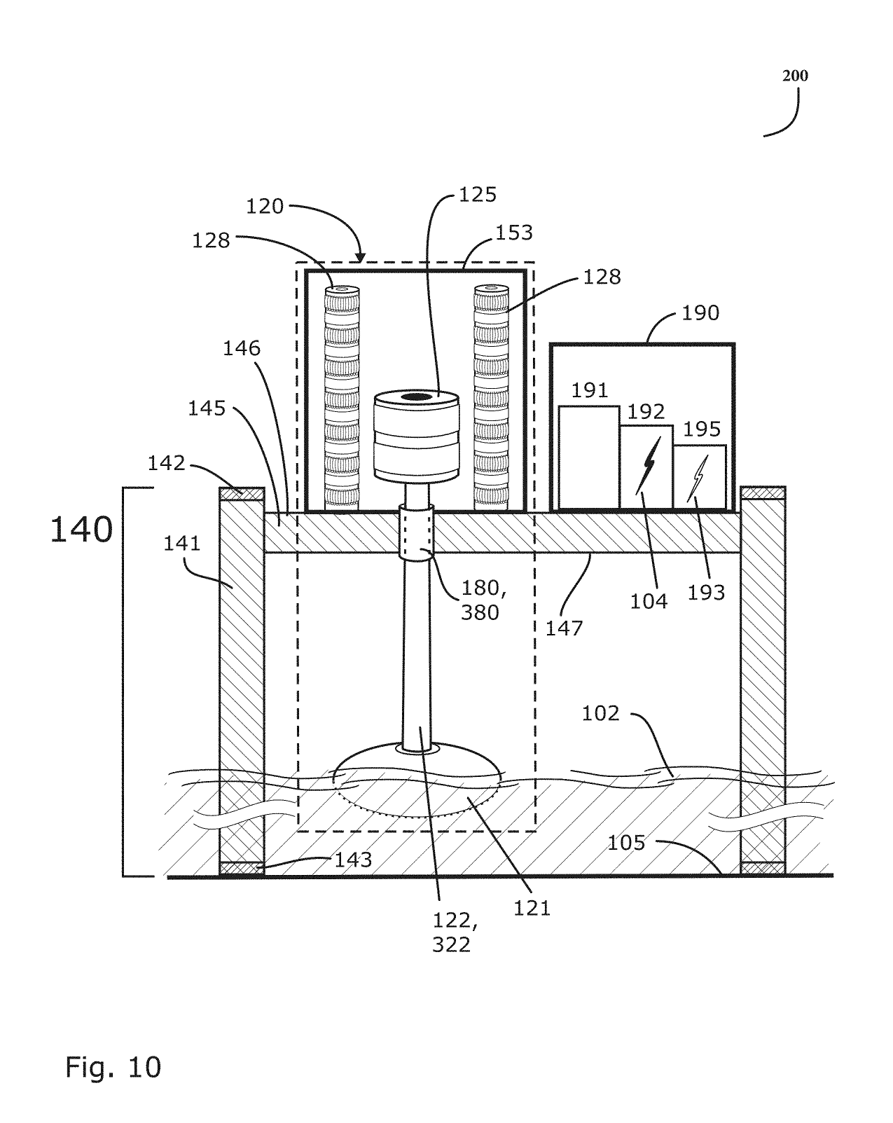

FIG. 7 shows a cutaway perspective view of an embodiment of at least one rod guide 180 in accordance with aspects of the present inventive concepts. The rod guide 180 has an interior surface 181 and an exterior surface 182. The exterior surface 182 is coupled to a support structure 140, as shown in FIG. 10, and the interior surface 181 at least partially surrounds the rod assembly 122 whereby supporting the rod assembly 122 vertically as the rod assembly 122 moves in response to the vertical force 103 of the kinetic energy of waves 101.

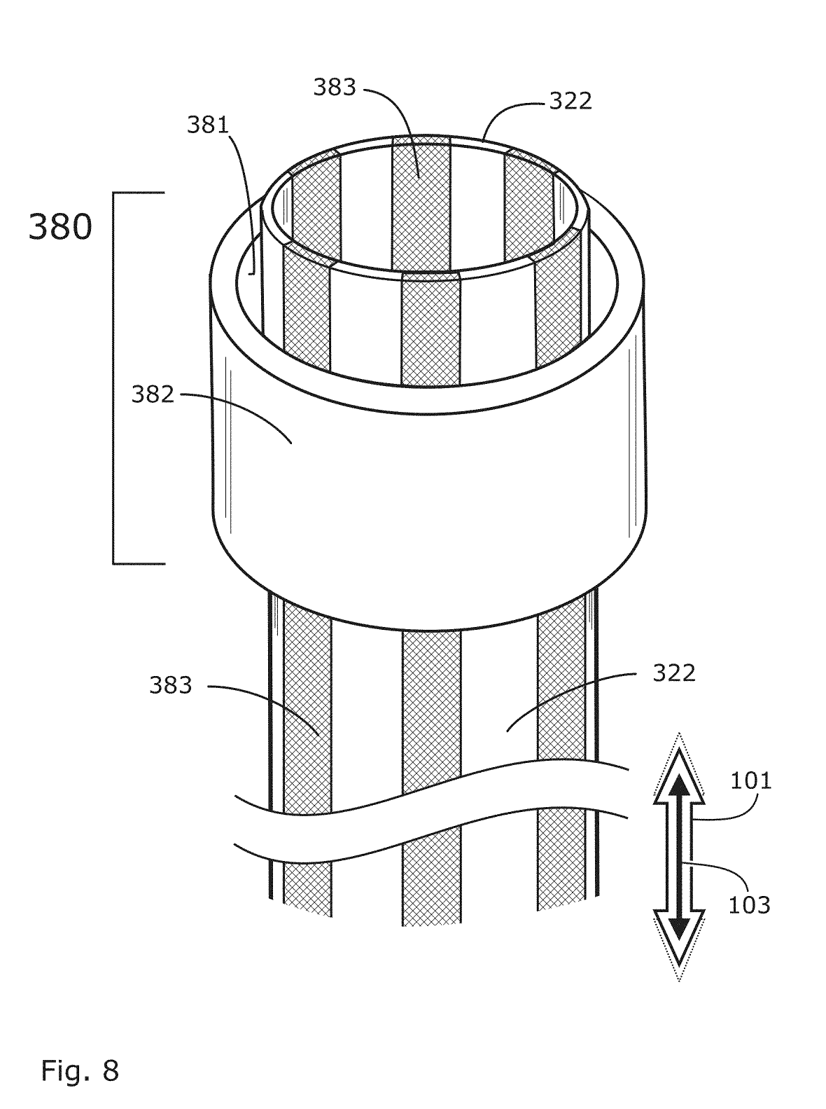

FIG. 8 shows a cutaway perspective view of another embodiment of at least one rod guide 380 in accordance with aspects of the present inventive concepts. The rod guide 380 has an interior surface 381 and an exterior surface 382. The exterior surface 382 is coupled to the support structure 140 as shown in FIG. 10, and the interior surface 381, having a magnetic polarity 384, at least partially surrounds at least one rod assembly 322. The rod assembly 322 comprises at least one rod magnet 383 having the magnetic polarity 384, and the magnetic polarity 384 of the interior surface 381 of the rod guide 380 opposes the magnetic polarity 384 of the rod magnet 383 to form a frictionless relationship between the rod assembly 322 and the rod guide 380 whereby the rod guide 380 supports the rod assembly 322 vertically, as shown in FIG. 10, and enables the rod assembly 322 to move frictionlessly in response to the vertical force 103 of the kinetic energy of waves 101.

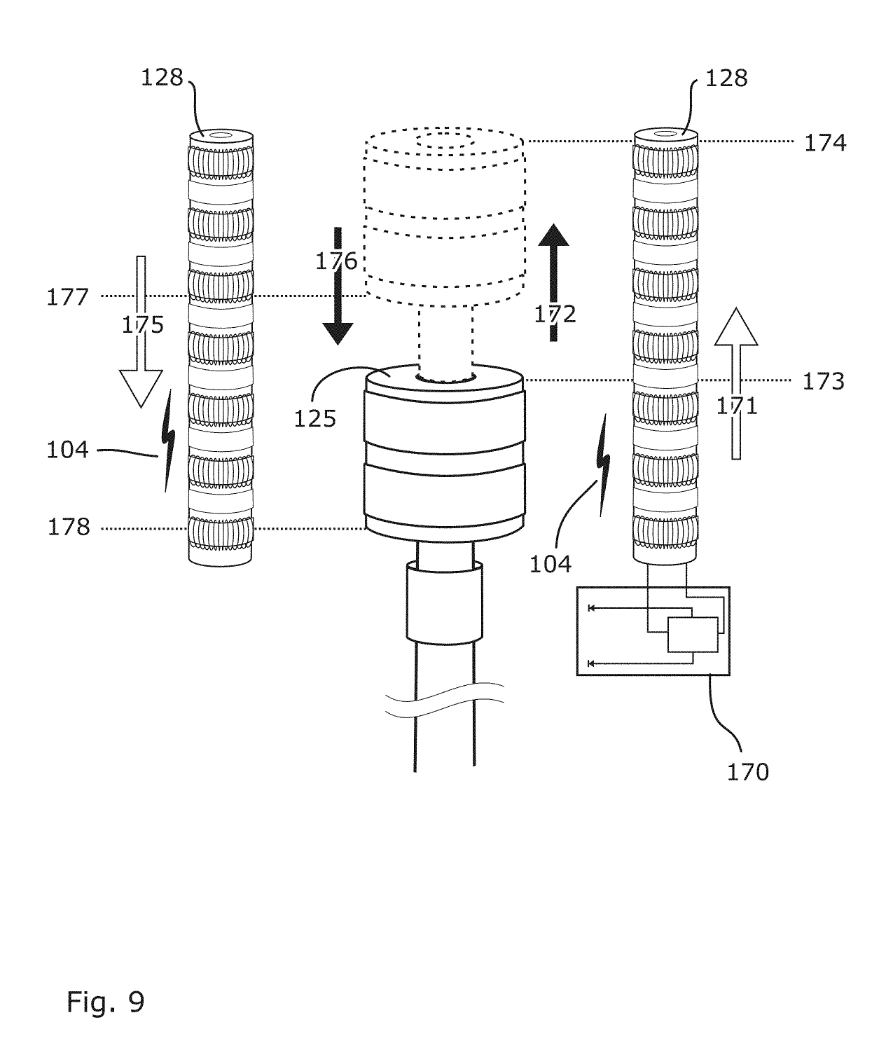

FIG. 9 shows a perspective view of an embodiment of at least one current inverter 170 in accordance with aspects of the present inventive concepts. The current inverter 170 converts the electricity 104 flowing in a second direction 175 into the electricity 104 flowing in a first direction 171. The magnet assembly 125 moves relative to the at least one coil assembly 128, whereby generating the electricity 104 at the coil assembly 128. The electricity 104 generated at the coil assembly 128 flows in the first direction 171 in response to the magnetic assembly 125 moving in the upward direction 172 relative to the coil assembly 128, and the electricity 104 moves in the second direction 175 in response to the magnetic assembly 125 moving in the downward direction 176 relative to the coil assembly 128. A current inverter 170, coupled to the coil assembly 128, converts the electricity 104 moving through the coil assembly 128 in the second direction 175 into the electricity 104 moving in the first direction 171, whereby moving all the electricity 104 generated at the coil assembly 128 in the first direction 171. As the magnetic assembly 125 moves in the upward direction 172 relative to the coil assembly 128 from a first position 173 to a second position 174, where the second position 174 is higher than the first position 173, the electricity 104 generated in the coil assembly 128 moves in the first direction 171. As the magnetic assembly 125 moves in the downward direction 176 relative to the coil assembly 128 from a third position 177 to a fourth position 178, where the fourth position 178 is lower than the third position 177, the electricity 104 generated at the coil assembly 128 moves in the second direction 175. The current inverter 170 changes the electricity 104 moving in the second direction 175 into the electricity 104 moving in the first direction 171, whereby all the electricity 104 generated at the coil assembly 128, in response to the magnetic assembly 125 moving in the upward direction 172 and the downward direction 176, moves in the first direction 171.

FIG. 10 shows a perspective view of an embodiment of an energy conversion system 200 in accordance with aspects of the present inventive concepts. The energy conversion system 200 comprises a support structure 140 coupled to at least one wave converter 120, and the support structure 140 supports the wave converter 120 at least partially above a body of water 102.

In an embodiment, as further shown in FIG. 10, the wave converter 120 is similar in construction, design and function as is described above with regard to FIGS. 1 through 9 and comprises at least one floating assembly 121, at least one rod assembly 122, 322 at least one magnetic assembly 125 and at least one coil assembly 128. The support structure 140 is coupled to a rod guide 180, 380 that at least partially surrounds the rod assembly 122, 322 whereby supporting the rod assembly 122, 322 vertically as the rod assembly 122, 322 moves in response to the floating assembly 121.

In an embodiment, as further shown in FIG. 10, the support structure 140 comprises at least one platform 145 having an upper surface 146 and a lower surface 147, and the platform 145 is coupled to at least one support leg 141 that supports the platform 145 above the body of water 102. The support leg 141 has a bottom end 143 coupled to a ground surface 105 and a top end 142 that extends above the body of water 102.

In an embodiment, as shown in FIG. 10, the wave converter 120 is coupled to the support structure 140, and the support structure 140 supports the wave converter 120 at least partially above the body of water 102. The wave converter 120 comprises the floating assembly 121, the rod assembly 122, the magnetic assembly 125 and coil assembly 128. The support structure 140 is coupled to a rod guide 180, 380 whereby supporting the rod assembly 122, 322 vertically as the rod assembly 122, 322 moves in response to the floating assembly 121.

In an embodiment, as shown in FIG. 10, the energy conversion system 200 further comprises a central control unit 190 coupled to the support structure 140 and the support structure 140 at least partially supports the central control unit above the body of water 102.

In an embodiment, as further shown in FIG. 10, a central control unit 190 is coupled to the platform 145 and comprises a primary power storage unit 191, a power transformer 192, and a power transfer unit 195. The primary power storage unit 191 is coupled to the wave converter 120 and stores the electricity 104 generated by the wave converter 120. The power transformer 192 converts the electricity 104 stored in the primary power storage unit 191 into a modified electricity 193 having a predetermined frequency waveform 194, and the power transfer unit 195 outputs the modified electricity 193.

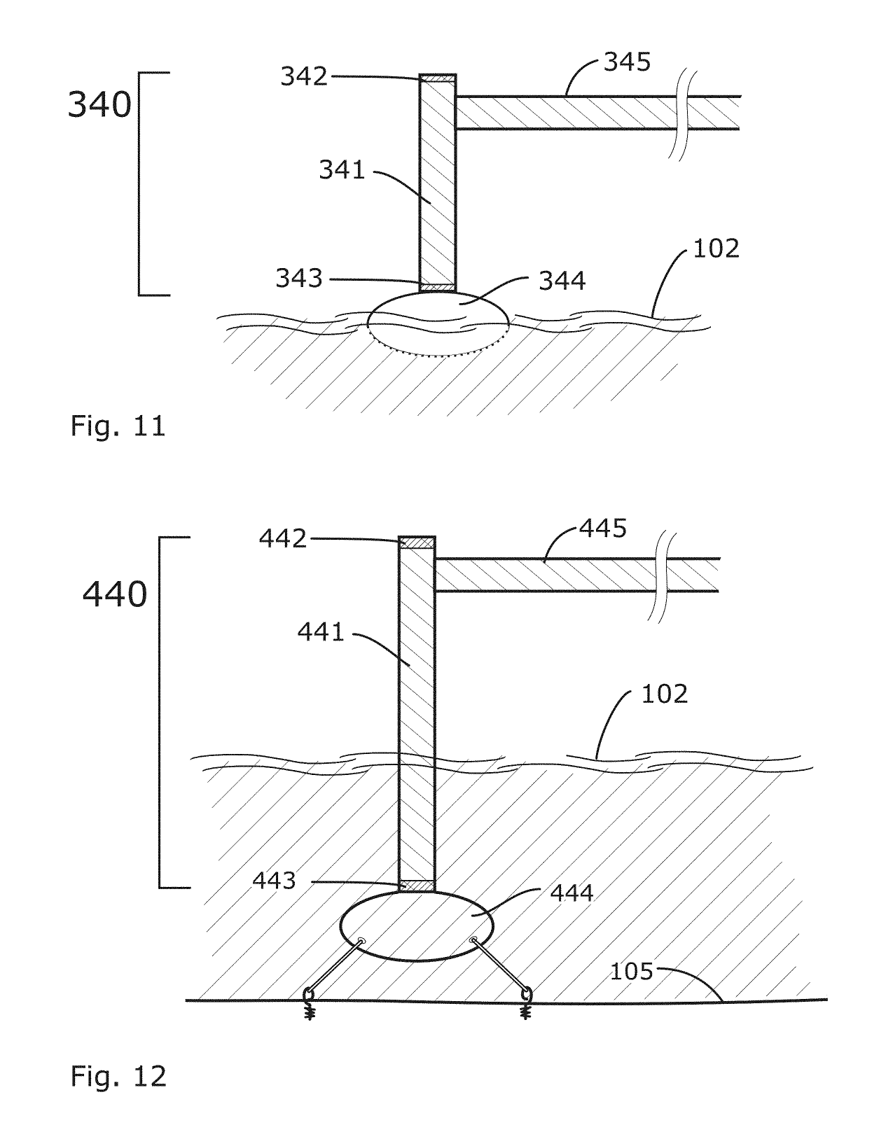

FIG. 11 shows a perspective view of an alternative embodiment of a support structure 340, in accordance with aspects of the present inventive concepts. The support structure 340 comprises at least one platform 345 coupled to at least one first support leg 341. The first support leg 341 has a top end 342 and a bottom end 343, and the bottom end 343 is coupled to at least one support buoy 344. The support leg 341 is secured vertically and the top end 342 of the support leg 341 is above the body of water 102. The support buoy 344, coupled to the support leg 341, is buoyant and at least partially floats on the body of water 102. The platform 345 is coupled to the support leg 341 whereby the support leg 341 supports the platform 345 horizontally above the body of water 102. Coupling the support leg 341 to the support buoy 344 enables the support structure 340 to float like a barge and can be moved from one water-based location to another by towing the support structure 340. The transportable property of the support structure 340 also enables it to be coupled to other support structures 340 that are towed to the same location, whereby enabling individual the support structure 340 to be manufactured and transported, and then coupled with multiple support structures 340 to form the support structure 340 in any size or configuration.

FIG. 12 shows a perspective view of an alternative embodiment of a support structure 440, in accordance with aspects of the present inventive concepts. The support structure 440 comprises at least one platform 445 coupled to at least one first support leg 441, whereby supporting the platform 445 horizontally above the body of water 102. The first support leg 441 has a top end 442 and a bottom end 443, and the bottom end 443 is coupled to at least one support buoy 444. The support leg 441 is secured vertically wherein the top end 442 of the support leg 441 is above the body of water 102. The support buoy 444 is coupled to the ground surface 105 wherein the support buoy 444 is submerged below the body of water 102. The support buoy 444 is buoyant, and coupling the support buoy 444 to the ground surface 105 prevents the support buoy 444 from floating on the body of water 102, whereby securing the support buoy 444 and the support leg 441 in a fixed position.

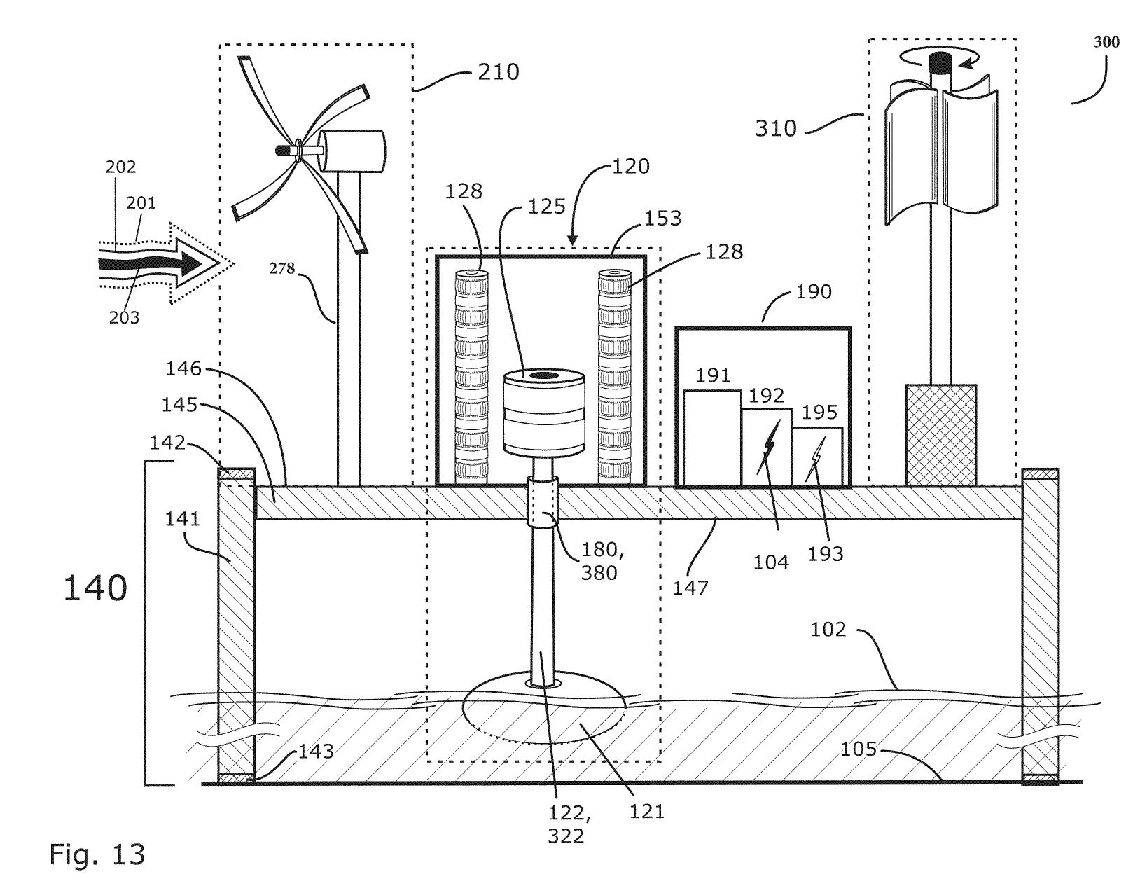

FIG. 13 shows a perspective view of an embodiment of an energy conversion system 300 in accordance with aspects of the present inventive concepts. The energy conversion system 300 comprises at least one wave converter 120 that converts kinetic energy of waves 101 of a body of water 102 into electricity 104, at least one wind converter 210 that converts kinetic energy of wind 201 into the electricity 104, and a support structure 140. The wave converter 120 and the wind converter 210 are coupled to the support structure 140, whereby the support structure 140 supports the wave converter 120 and the wind converter 210 at least partially above the body of water 102. It should be understood that any reference to the wind converter 210 pertaining to FIG. 13 may be a reference to the wind converter 210 or the wind converter 310.

In an embodiment, as further shown in FIG. 13, the wave converter 120 is similar in construction, design and function as is described above with regard to FIGS. 1 through 9 and comprises at least one floating assembly 121, at least one rod assembly 122, at least one magnetic assembly 125 and at least one coil assembly 128. The floating assembly 121 is buoyant and at least partially floats on the body of water 102, whereby moving in response to the movement of the body of water 102. The floating assembly 121 is coupled to the rod assembly 122 and the rod assembly 122 moves in response to the movement of the floating assembly 121. At least one rod guide 180 is coupled to the support structure 140 and at least partially surrounds the rod assembly 122, whereby vertically supporting the rod assembly 122 and enabling the rod assembly 122 to move in response to the movement of the floating assembly 121. It should be understood that any reference to the rod guide 180 pertaining to FIG. 13 is may be a reference to the rod guide 180 or rod guide 380. The magnetic assembly 125 is coupled to the rod assembly 122 and moves in response to the movement of the floating assembly 121. The coil assembly 128 is adjacent and at least partially surrounds the magnetic assembly 125. A housing 153 at least partially surrounds the magnetic assembly 125 and the coil assembly 128, wherein the magnetic assembly 125 moves relative to the coil assembly 128 in response to the movement of the floating assembly 121. Moving the magnetic assembly 125 relative to the coil assembly 128 generates the electricity 104 at the coil assembly 128.

In an embodiment, as further shown in FIG. 13, a support assembly 278 couples the wind converter 210 to the support structure 140.

In an embodiment, as further shown in FIG. 13, the support structure 140 comprises at least one platform 145 having an upper surface 146 and a lower surface 147, and the platform 145 is coupled to at least one support leg 141 that supports the platform 145 above the body of water 102. The support leg 141 has a bottom end 143 coupled to a ground surface 105 and a top end 142 that extends above the body of water 102.

In another embodiment, as shown in FIG. 11, a support structure 340 comprises at least one platform 345 coupled to at least one first support leg 341. The first support leg 341 has a top end 342 and a bottom end 343, and the bottom end 343 is coupled to at least one support buoy 344. The support leg 341 is secured vertically and the top end 342 of the support leg 341 is above the body of water 102. The support buoy 344, coupled to the support leg 341, is buoyant and at least partially floats on the body of water 102. The platform 345 is coupled to the support leg 341 whereby the support leg 341 supports the platform 345 horizontally above the body of water 102.

In another embodiment, as shown in FIG. 12, a support structure 440 comprises at least one platform 445 coupled to at least one first support leg 441. The first support leg 441 has a top end 442 and a bottom end 443, and the bottom end 443 is coupled to at least one support buoy 444. The support leg 441 is secured vertically wherein the top end 442 of the support leg 441 is above the body of water 102. The support buoy 444 is coupled to the ground surface 105 wherein the support buoy 444 is submerged below the body of water 102. The support buoy 444 is buoyant, and coupling the support buoy 444 to the ground surface 105 prevents the support buoy 444 from floating on the body of water 102, whereby securing the support buoy 444 and the support leg 441 in a fixed position. A platform 145B is coupled to the support leg 141B, whereby supporting the platform 145B horizontally above the body of water 102.

In an embodiment, as shown in FIG. 10, a central control unit 190 is coupled to the platform 145. The central control unit comprises a primary power storage unit 191, a power transformer 192, and a power transfer unit 195. The primary power storage unit 191 is coupled to the wave converter 120 and stores the electricity 104 generated by the wave converter 120. The power transformer 192 converts the electricity 104 stored in the primary power storage unit 191 into a modified electricity 193 having a predetermined frequency waveform 194, and the power transfer unit 195 outputs the modified electricity 193.

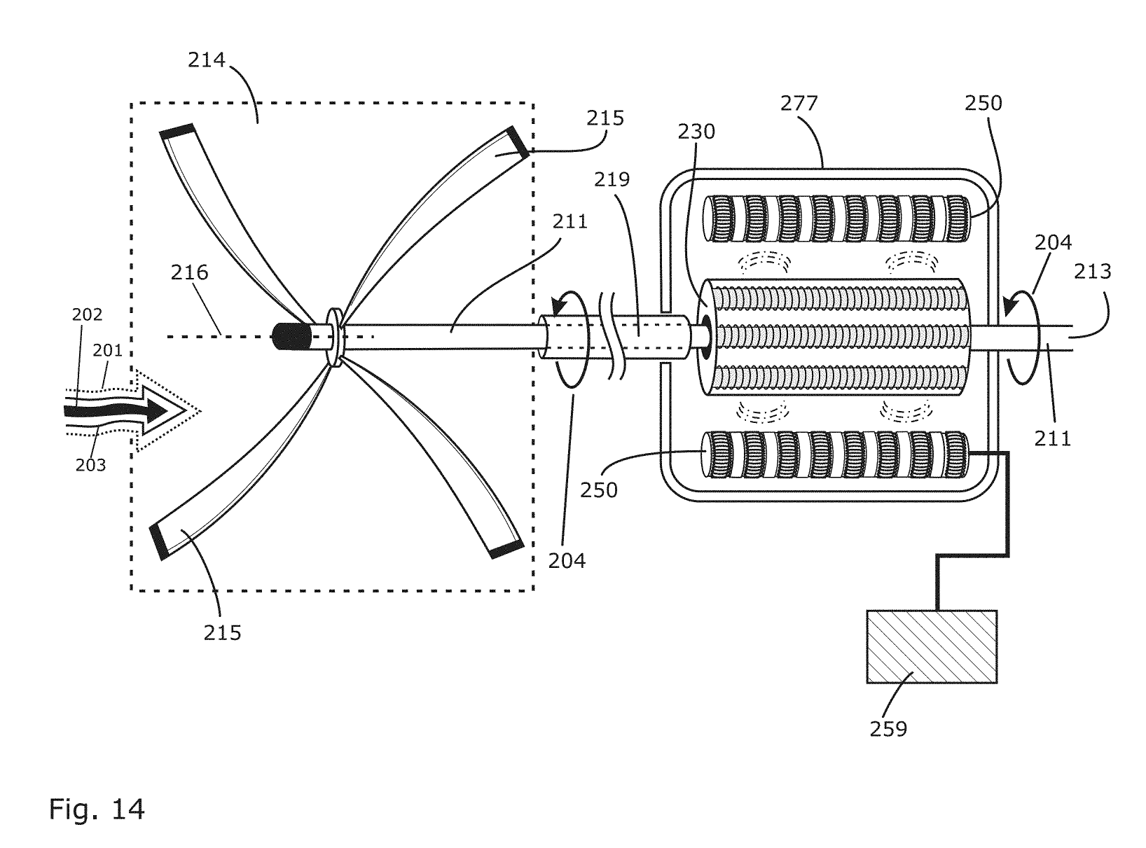

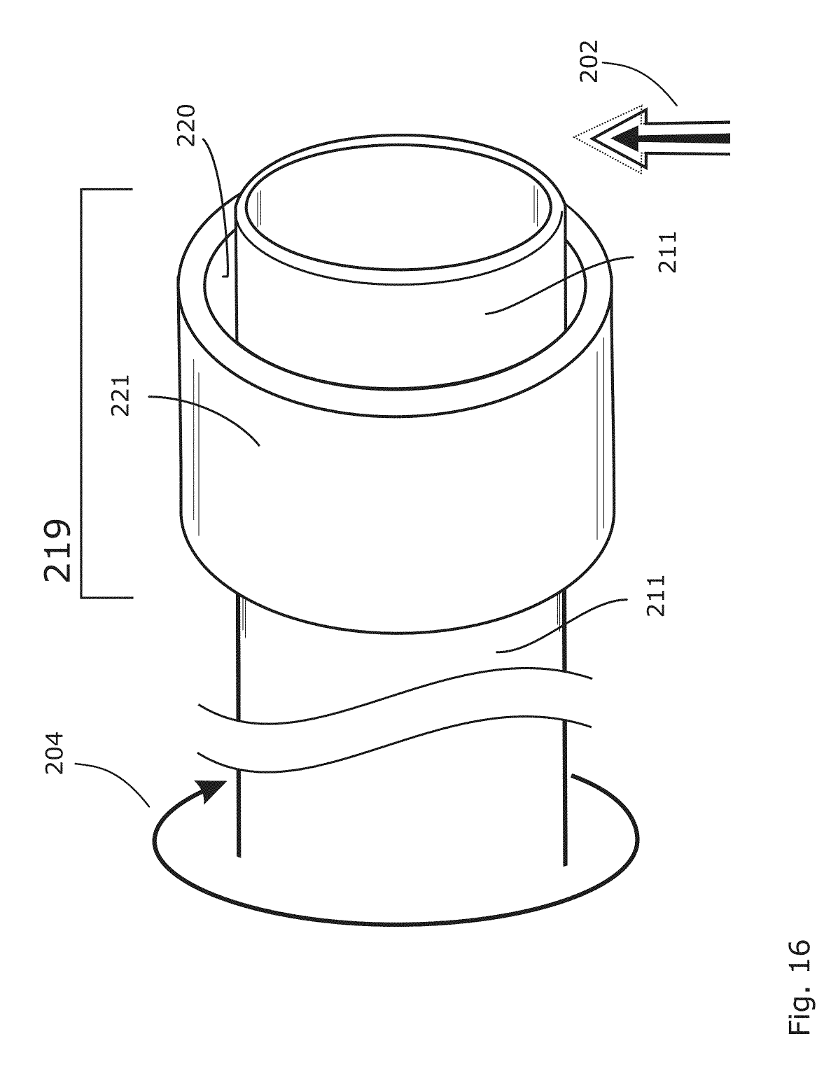

FIG. 14 shows a perspective view an embodiment of the wind converter 210 in accordance with aspects of the present inventive concepts. The wind converter 210 comprises an axel 211, at least one wind collector 214, at least one axel guide 219, at least one wind magnetic assembly 230, at least one wind coil assembly 250, a wind converter housing 277, and the support assembly 278 as shown in FIG. 13. The axel 211 has a first axel end 212 and a second axel end 213, and the wind collector 214 is coupled to the axel 211. The wind collector 214 collects the kinetic energy of the wind 201, having a horizontal force 202 and a direction 203, whereby producing a rotational force 204 applied to the axel 211, wherein the rotational force 204 is relative to the horizontal force 202. Increasing the horizontal force 202 applied to the wind collector 214 increases the rotational force 204 applied to the axel 211. Decreasing the horizontal force 202 decreases the rotational force 204. The axel 211 is supported horizontally by the axel guide 219 that at least partially surrounding the axel 211 whereby enabling the axel 211 to rotate in response to the horizontal force 202 applied to the wind collector 214. The wind magnetic assembly 230 is coupled to the axel 211, and the wind magnetic assembly 230 rotates in response to the rotational force 204 applied to the axel 211. The wind coil assembly 250 is positioned adjacent the wind magnetic assembly 230, and the wind coil assembly 250 at least partially surrounds the wind magnetic assembly 230. Rotating the wind magnetic assembly 230 in response to the horizontal force 202 applied to the at least one wind collector 214 generates the electricity 104 at the wind coil assembly 250.

FIGS. 13 and 14 show a perspective view of an embodiment of at least one wind collector 214 of the wind converter 210 in accordance with aspects of the present inventive concepts. The wind collector 214 is coupled to the axel 211, and the axel 211 is positioned horizontally and parallel to the direction 203 of the kinetic energy of the wind 201 to maximize the horizontal force 202 applied to the wind collector 214, whereby maximizing the rotational force 204 around a horizontal axis 216 of the axel 211. The wind collector 214 comprises at least one elongated propeller 215 designed and configured to apply the rotational force 204 to the axel 211 in response to the horizontal force 202.

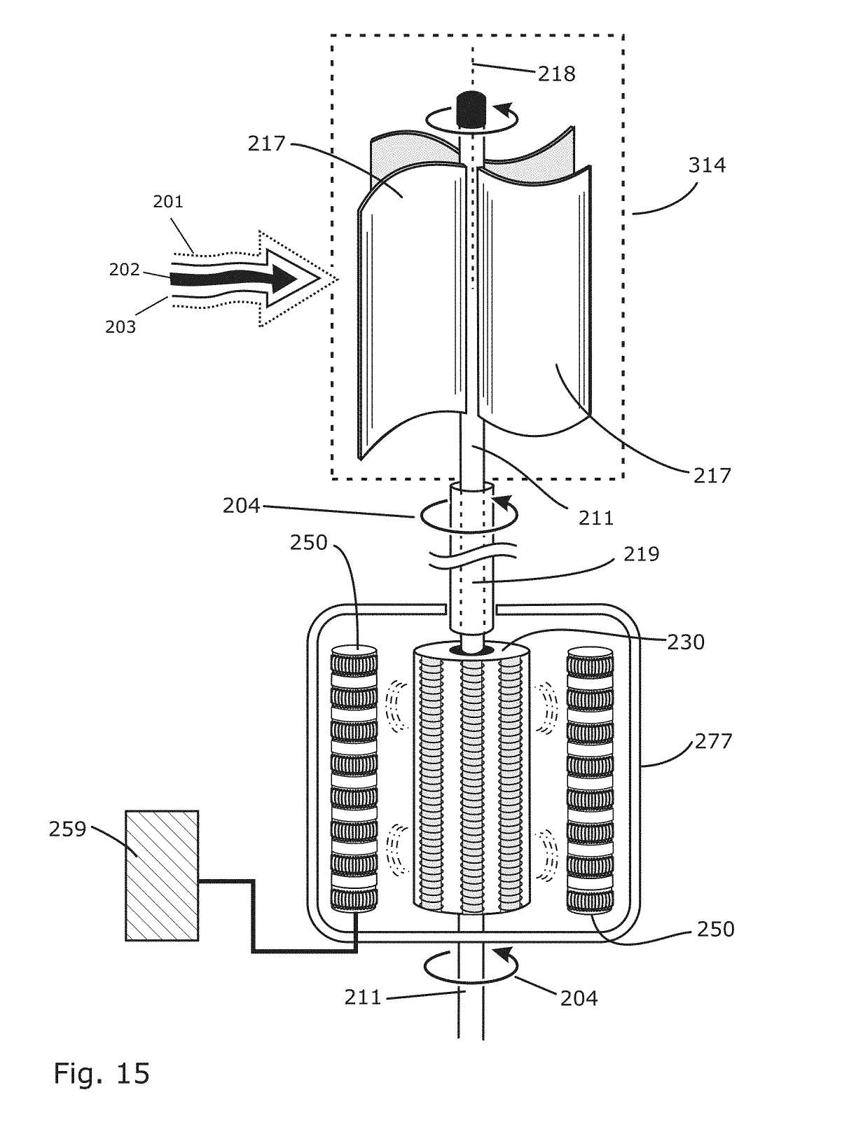

FIGS. 13 and 15 show a perspective view of another embodiment of at least one wind collector 314 of the wind converter 310 in accordance with aspects of the present inventive concepts. The wind collector 314 is coupled to the axel 211, and the axel 211 is positioned vertically and perpendicular to the direction 203 of the kinetic energy of the wind 201 to maximize the horizontal force 202 applied to the wind collector 314, whereby maximizing the rotational force 204 around a vertical axis 218 of the axel 211. The wind collector 314 comprises at least one elongated scoop 217 designed and configured to apply the rotational force 204 to the axel 211 in response to the horizontal force 202.

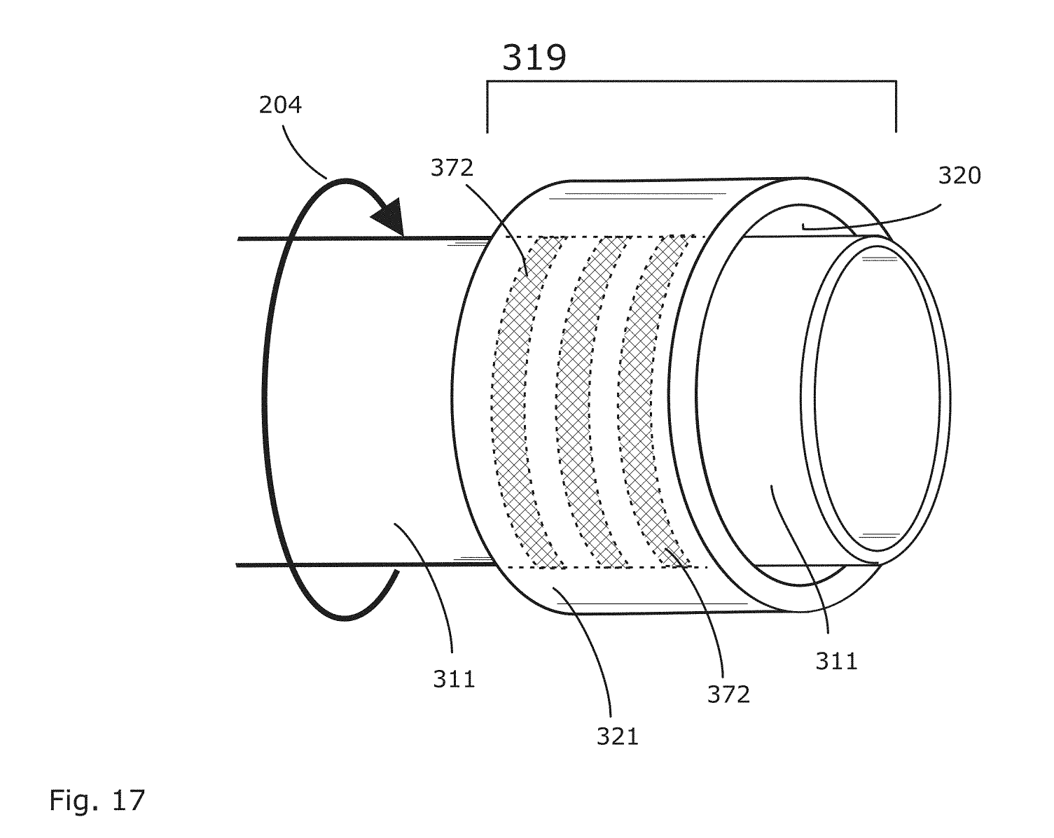

FIG. 16 shows a cutaway perspective view of an embodiment of at least one axle guide 219 in accordance with aspects of the present inventive concepts. The axel guide 219 includes an interior guide surface 220 and an exterior guide surface 221. The exterior guide surface 221 is indirectly coupled to a wind converter housing 277, shown in FIGS. 14 and 15, and the interior guide surface 220 at least partially surrounds the axel 211 whereby movably supporting the axel 211 either horizontally or vertically, whereby enabling the axel 211 to rotate in response to the rotational force 204 applied by the horizontal force 202.

In another embodiment, as shown in FIG. 17, at least one axle guide 319 has an interior guide surface 320 having a magnetic polarity 371, and an exterior guide surface 321 indirectly coupled to the wind converter housing 277, shown in FIGS. 14 and 15. The axel 311 comprises at least one axel magnet 372 having the magnetic polarity 371. The interior guide surface 320 of the axle guide 319 at least partially surrounds the axel 311 and is positioned opposite the axel magnet 372. The interior guide surface 320 of the axel guide 319, having the magnetic polarity 371 directly opposes the axel magnet 372 having the magnetic polarity 371 and forms a frictionless relationship between the axle guide 319 and the axel magnet 372, whereby enabling the axel 311 to rotate frictionlessly in response to the rotational force 204 applied by the horizontal force 202.

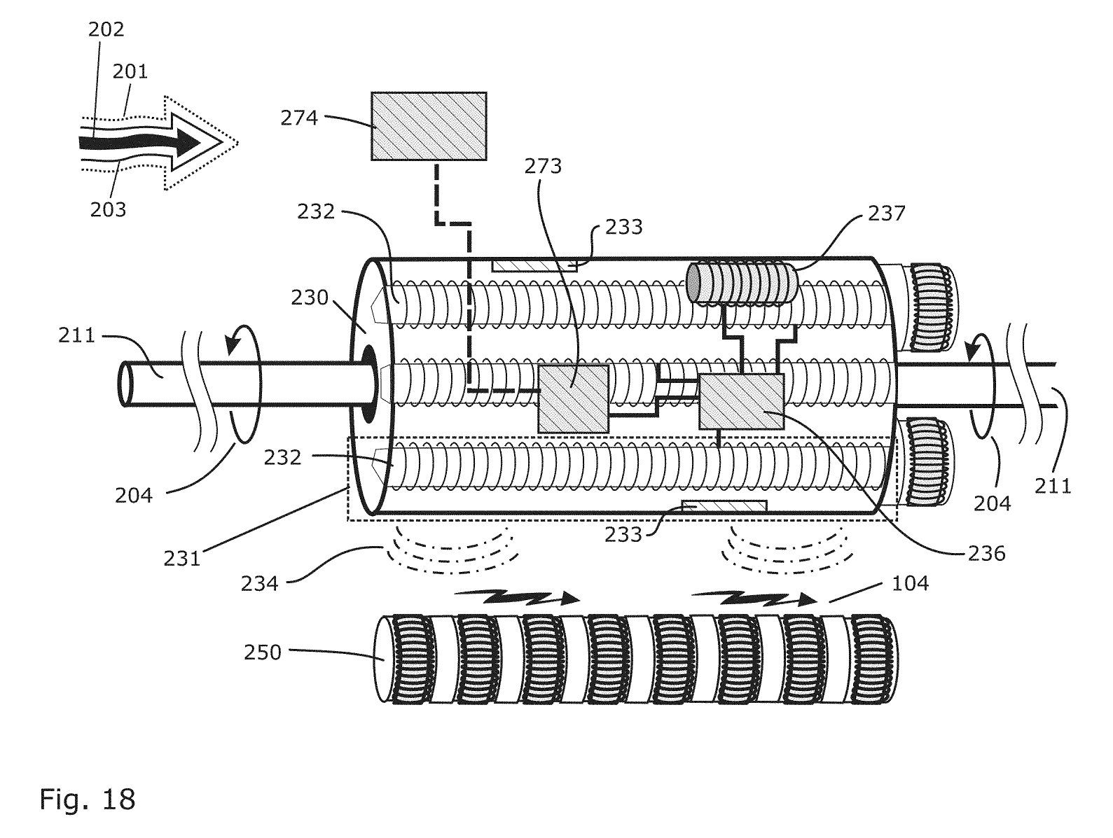

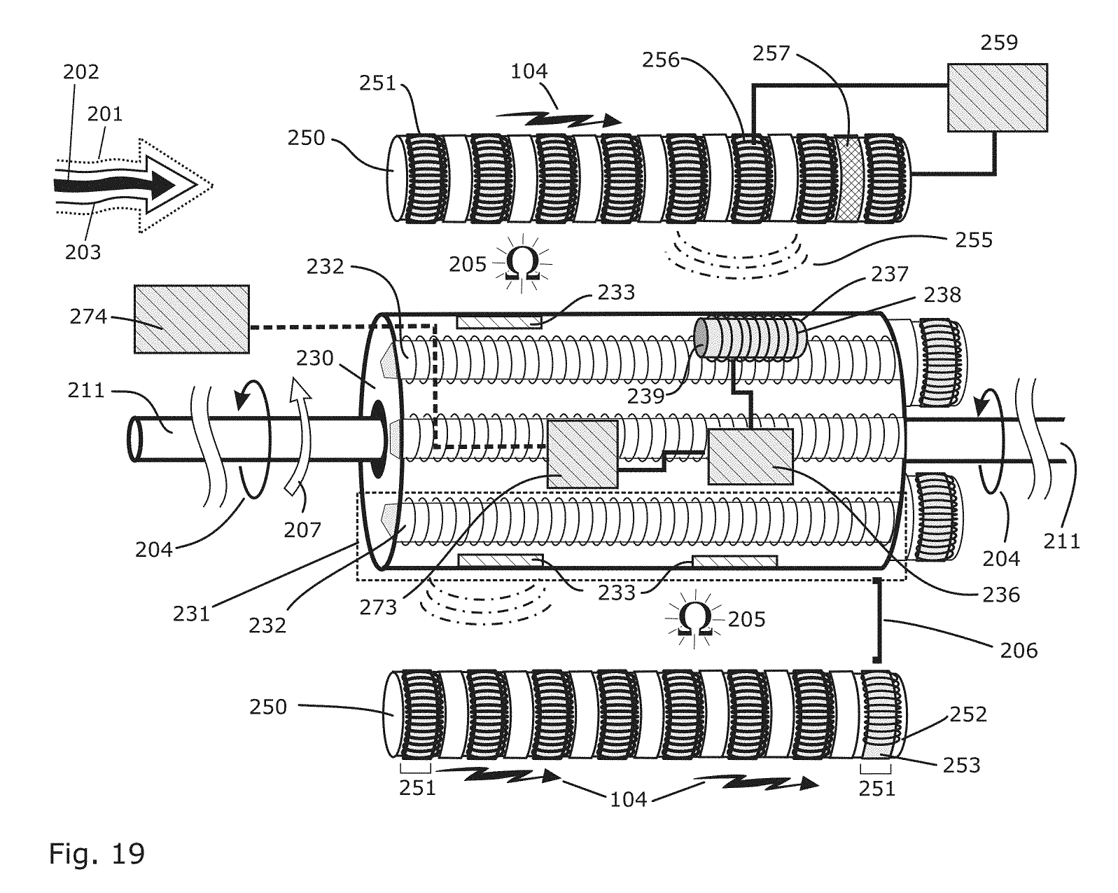

FIG. 18 shows a perspective view of an embodiment of the wind magnetic assembly 230 in accordance with aspects of the present inventive concepts. The wind magnetic assembly 230 comprises at least one wind magnet 231, at least one wind power source 236, and at least one wind charger 237. The wind magnet 231 comprises at least one of at least one wind electromagnet 232 and/or at least one wind permanent magnet 233, and the wind magnet 231 produces at least one wind magnetic field 234 having at least one wind magnetic strength 235. The wind magnetic field 234 is produced by the wind electromagnet 232 and/or the wind permanent magnet 233, and the wind power source 236 is coupled to the wind electromagnet 232 to power the wind electromagnet 232. The wind charger 237, having a first conductive wind wire 238 wrapped around a first conductive wind core 239, is coupled to the wind power source 236 to charge the wind power source 236.

In an embodiment, a wind assembly controller 273 is coupled to the wind power source 236 to adjust the wind magnetic strength 235 of the wind magnetic field 234 relative to the rotational force 204 applied to the axel 211. A wind gauge 274, in communication with the wind assembly controller 273, measures the direction 203 and the horizontal force 202 applied by the kinetic energy of the wind 201 and adjusts the wind magnetic strength 235 of the wind magnetic field 234 relative to the horizontal force 202 to maximize the electricity 104 generated at the wind coil assembly 250.

In an embodiment, the wind charger 237 may be constructed and arranged to have different configurations known to one of ordinary skill in the art to promote efficacy of the generation of the electricity 104 at the first conductive wind wire 238.

In an embodiment, the first conductive wind wire 238 may be formed of an electrically conductive material or blend of materials, such as copper, aluminum, etc., known to one of ordinary skill in the art to promote efficacy of the generation of the electricity 104 at the first conductive wind wire 238.

In an embodiment, the first conductive wind wire 238 may have different shapes, such as flattened, spring-shaped, hexagonal, etc., known to one of ordinary skill in the art to promote efficacy of the generation of the electricity 104 at the first conductive wind wire 238.

In an embodiment, the first conductive wind core 239 may be formed of a material or blend of materials known to one of ordinary skill in the art to promote efficacy of the generation of the electricity 104 at the first conductive wind wire 238.

FIG. 19 shows a perspective view of an embodiment of the wind coil assembly 250 in accordance with aspects of the present inventive concepts. The wind coil assembly 250 comprises at least one conductive wind coil 251, having at least one second conductive wind wire 252 coiled around at least one second conductive wind core 253. As the axel 211 rotates in response to the rotational force 204, the wind magnetic assembly 230 rotates relative to the wind coil assembly 250. The wind coil assembly 250 is adjacent and at least partially surrounds the wind magnetic assembly 230. Moving the wind magnetic field 234 of the wind magnet 231 relative to the conductive wind coil 251 of the wind coil assembly 250 generates the electricity 104 at the conductive wind coil 251. The wind coil assembly 250 further comprises at least one of at least one wind coil electromagnet 256 and/or at least one wind coil permanent magnet 257, wherein the wind coil electromagnet 256 and/or the wind coil permanent magnet 257 produces at least one wind coil magnetic field 255 having a wind coil magnetic strength 258.

As further shown in FIG. 19, a wind load resistance 205 is produced between the wind magnetic assembly 230 and the wind coil assembly 250. The wind magnetic assembly 230 is coupled to the axel 211, wherein the axel 211 rotates at a rotational rate 207 in response to the rotational force 204 applied by the horizontal force 202. Rotating the wind magnetic assembly 230, having the wind magnetic field 234 having the wind magnetic strength 235, relative to the wind coil assembly 250 produces the wind load resistance 205 whereby impeding movement of the wind magnetic assembly 230 relative to the wind coil assembly 250. The wind gauge 274, in communication with the wind assembly controller 273, adjusts the wind magnetic strength 235 of the wind magnetic field 234 in relation to the horizontal force 202, whereby varying the electricity 104 generated at the wind coil assembly 250 and varying the wind load resistance 205 between the wind coil assembly 250 and the wind magnetic assembly 230. Increasing the wind magnetic strength 235 of the wind magnetic field 234 increases the wind load resistance 205, and also increases the horizontal force 202 necessary to move the wind magnetic assembly 230 relative to the wind coil assembly 250. Decreasing the wind magnetic strength 235 decreases the wind load resistance 205 and decreases the electricity 104 generated in the wind coil assembly 250, and also decreases the horizontal force 202 necessary to move the wind magnetic assembly 230 relative to the wind coil assembly 250. The wind coil assembly 250 and the wind magnetic assembly 230 are separated by a separation gap 206. Moving the wind coil assembly 250 through the wind magnetic field 234 generates the electricity 104 at the wind coil assembly 250, wherein the electricity 104 generated is inversely proportional to the separation gap 206. Increasing the separation gap 206 decreases the electricity 104 generated in the wind coil assembly 250, and decreasing the separation gap 206 increases the electricity 104 generated in the wind coil assembly 250 Minimizing the separation gap 206 between the wind coil assembly 250 and the wind magnetic assembly 230 maximizes the electricity 104 generated in the wind coil assembly 250. The wind coil assembly 250 moves through the wind magnetic field 234 relative to the wind magnetic assembly 230 with the rotational rate 207 in response to the rotational force 204 applied by the horizontal force 202. The electricity 104 generated in the wind coil assembly 250 is directly related to the rotational rate 207. Increasing the rotational rate 207 increases the electricity 104 generated in the wind coil assembly 250, and decreasing the rotational rate 207 decreases the electricity 104 generated in the wind coil assembly 250. The wind coil assembly 250 moves through the wind magnetic field 234 relative to the wind magnetic assembly 230 with the rotational rate 207 whereby generating the electricity 104 at the wind coil assembly 250 and whereby generating the wind load resistance 205 between the wind coil assembly 250 and the wind magnetic assembly 230. Increasing the wind load resistance 205 decreases the rotational rate 207. Increasing the wind magnetic strength 235 of the increases the electricity 104 generated at the wind coil assembly 250 and increases the wind load resistance 205 whereby decreasing the rotational rate 207. Decreasing the wind magnetic strength 235 decreases the electricity 104 generated at the wind coil assembly 250 and decreases the wind load resistance 205 whereby increasing the rotational rate 207. Therefore, adjusting the wind magnetic strength 235 of the wind magnetic field 234 in relation to the horizontal force 202 maximizes the electricity 104 generated in the wind coil assembly 250, whereby adjusting the wind load resistance 205 to optimize the rotational rate 207 of the wind coil assembly 250 moving relative to the wind magnetic field 234.

The wind charger 237, having the first conductive wind wire 238 wrapped around the first conductive wind core 239, is coupled to the wind power source 236. Moving the wind charger 237 through the wind coil magnetic field 255 generates the electricity 104 at the first conductive coil 239, whereby charging the wind power source 236 to power the wind electromagnet 232. The wind assembly controller 273 is coupled to the wind electromagnet 232 to adjust the wind magnetic strength 235 of the wind magnetic field 234 relative to the horizontal force 202 applied by the kinetic energy of the wind 201. The wind gauge 274, in communication with the wind assembly controller 273, measures the direction 203 applied by the kinetic energy of the wind 201 wherein the wave gauge 274 adjusts the wind magnetic strength 235 of the wind magnetic field 234 to maximize the electricity 104 generated in the wind coil assembly 250 relative to the horizontal force 202.

In an embodiment, an insulating material 134 as described in FIG. 3 may be introduced between the conductive wind coils 251 to separate each of the conductive wind coils 251.

In an embodiment, the insulating material 134 described in FIG. 3 may be an electrically nonconductive material, such as plastic, rubber, etc., known to one of ordinary skill in the art.

In an embodiment, the conductive wind coil 251 may be constructed and arranged to have different configurations known to one of ordinary skill in the art to promote efficacy of the generation of the electricity 104 at the second conductive wind wire 252 as the conductive wind coil 251 passes through the wind magnetic field 234.

In an embodiment, the second conductive wind wire 252 may be formed of an electrically conductive material or blend of materials, such as copper, aluminum, etc., known to one of ordinary skill in the art to promote efficacy of the generation of the electricity 104 at the second conductive wind wire 252 as the conductive wind coil 251 passes through the wind magnetic field 234.

In an embodiment, the second conductive wind wire 252 may have different shapes, such as flattened, spring-shaped, hexagonal, etc., known to one of ordinary skill in the art to promote efficacy of the generation of the electricity 104 at the second conductive wind wire 252 as the conductive wind coil 251 passes through the wind magnetic field 234.

In an embodiment, the second conductive wind core 253 may be formed of a material or blend of materials known to one of ordinary skill in the art to promote efficacy of the generation of the electricity 104 at the second conductive wind wire 252 as the conductive wind coil 351 passes through the wind magnetic field 234.

FIG. 20 shows a perspective view of an embodiment of an energy conversion system 400 in accordance with aspects of the present inventive concepts. The energy conversion system 400 comprises a support structure 140 coupled to at least one wave converter 120, at least one of at least one solar converter 410 or at least one solar converter 510, and a central control unit 190, wherein the support structure 140 supports the wave converter 120, the solar converter 410 and/or the solar converter 510, and the central control unit 190 at least partially above a body of water 102. The wave converter 120 converts kinetic energy of waves 101 of a body of water 102 into electricity 104, the solar converter 410 and or the solar converter 510 converts solar energy of sunlight 401 into the electricity 104, and the electricity 104 is stored at the central control unit. In reference to FIG. 20, it should be understood that any reference to the solar converter 410 refers to the solar converter 410 and/or the solar converter 510.

In an embodiment, the wave converter 120 is similar in construction, design and function as is described above with regard to FIGS. 1 through 9 and comprises at least one floating assembly 121, at least one rod assembly 122, at least one magnetic assembly 125 and at least one coil assembly 128. The floating assembly 121 is buoyant and at least partially floats on the body of water 102, whereby moving in response to the movement of the body of water 102. The floating assembly 121 is coupled to the rod assembly 122 and the rod assembly 122 moves in response to the movement of the floating assembly 121. At least one rod guide 180 is coupled to the support structure 140 and at least partially surrounds the rod assembly 122, whereby vertically supporting the rod assembly 122 and enabling the rod assembly 122 to move in response to the movement of the floating assembly 121. The magnetic assembly 125 is coupled to the rod assembly 122 and moves in response to the movement of the floating assembly 121. The coil assembly 128 is adjacent and at least partially surrounds the magnetic assembly 125. A housing 153 at least partially surrounds the magnetic assembly 125 and the coil assembly 128, wherein the magnetic assembly 125 moves relative to the coil assembly 128 in response to the movement of the floating assembly 121. Moving the magnetic assembly 125 relative to the coil assembly 128 generates the electricity 104 at the coil assembly 128.

In an embodiment, as shown in FIG. 20, the support structure 140 comprises at least one platform 145 having an upper surface 146 and a lower surface 147, and the platform 145 is coupled to at least one support leg 141 that supports the platform 145 above the body of water 102. The support leg 141 has a bottom end 143 coupled to a ground surface 105 and a top end 142 that extends above the body of water 102.

In an embodiment, as shown in FIG. 11, a support structure 340 comprises at least one platform 345 coupled to at least one first support leg 341. The first support leg 341 has a top end 342 and a bottom end 343, and the bottom end 343 is coupled to at least one support buoy 344. The support leg 341 is secured vertically and the top end 342 of the support leg 341 is above the body of water 102. The support buoy 344, coupled to the support leg 341, is buoyant and at least partially floats on the body of water 102. The platform 345 is coupled to the support leg 341 whereby the support leg 341 supports the platform 345 horizontally above the body of water 102.

In an embodiment, as shown in FIG. 12, a support structure 440 comprises at least one platform 445 coupled to at least one first support leg 441. The first support leg 441 has a top end 442 and a bottom end 443, and the bottom end 443 is coupled to at least one support buoy 444. The support leg 441 is secured vertically wherein the top end 442 of the support leg 441 is above the body of water 102. The support buoy 444 is coupled to the ground surface 105 wherein the support buoy 444 is submerged below the body of water 102. The support buoy 444 is buoyant, and coupling the support buoy 444 to the ground surface 105 prevents the support buoy 444 from floating on the body of water 102 whereby securing the support buoy 444 and the support leg 441 in a fixed position. The platform 445 is coupled to the support leg 441, whereby supporting the platform 445 horizontally above the body of water 102.

In an embodiment, referring to FIG. 12, the support structure 440 is secured in a fixed position by threading a retractable cable through the support buoy 444 and coupling a first cable end of the retractable cable to an anchor on the ground surface 105 and coupling a second cable end of the retractable cable to a motorized winch. By extending or retracting the retractable cable, the motorized winch increases or decreases the span between the support buoy 444 and the anchor, whereby adjusting the span between the platform 445 and the body of water 102.

In an embodiment, as shown in FIG. 20, the central control unit 190 is coupled to the platform 145. The central control unit comprises a primary power storage unit 191, a power transformer 192, and a power transfer unit 195. The primary power storage unit 191 is coupled to the wave converter 120 and stores the electricity 104 generated by the wave converter 120. The power transformer 192 converts the electricity 104 stored in the primary power storage unit 191 into a modified electricity 193 having a predetermined frequency waveform 194, and the power transfer unit 195 outputs the modified electricity 193.

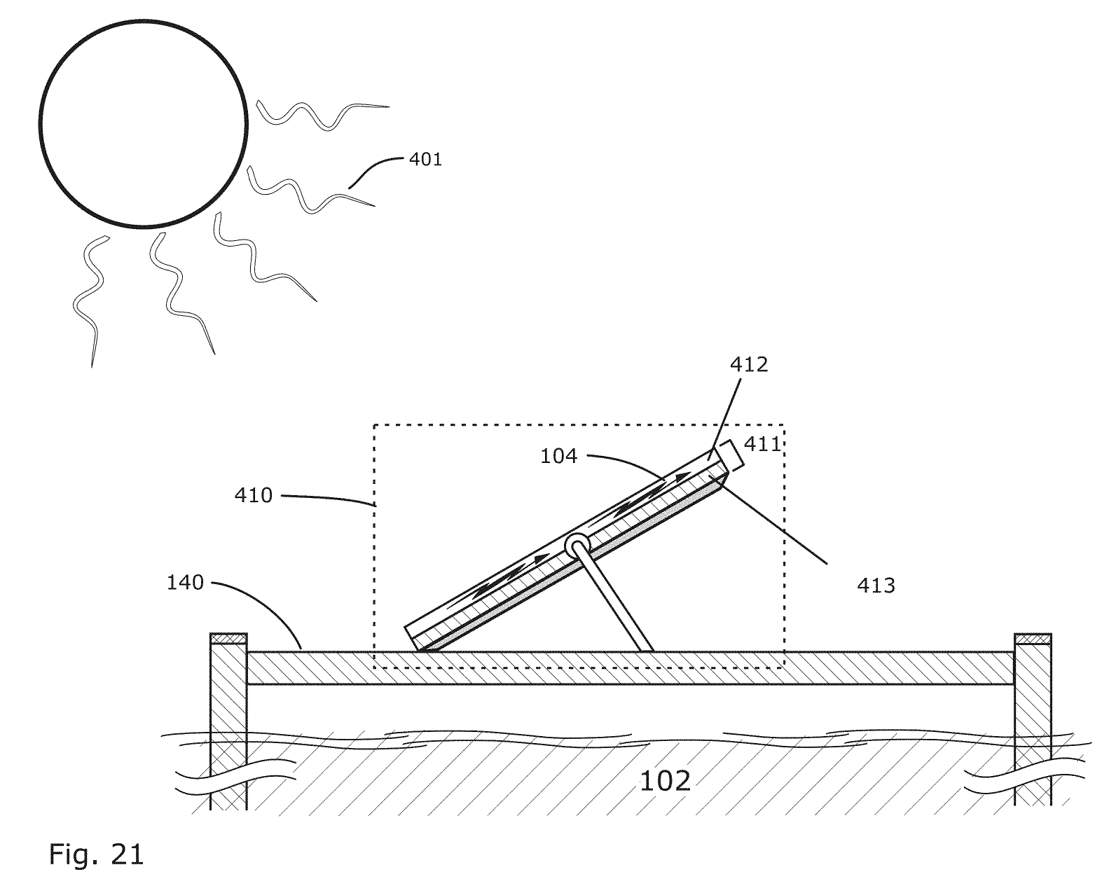

FIG. 21 shows a perspective view of an embodiment of the solar converter 410 coupled to the support structure 140 in accordance with aspects of the present inventive concepts.

In an embodiment, as shown in FIG. 21, the solar converter 410 comprises at least one solar receptor 411 that has an absorbing surface 412 and a non-absorbing surface 413. The absorbing surface 412 of the solar receptor 411 is exposed to the solar energy of the sunlight 401 and converts the solar energy of the sunlight 401 into the electricity 104. The solar converter 410 may be directly or indirectly coupled to the support structure 140 whereby the support structure 140 supports the solar converter above the body of water 102.

In an embodiment, the absorbing surface 412 of the solar receptor 411 includes solar devices, such as photoelectric cells, photovoltaic cells, etc., for converting the solar energy of the sunlight 401 into the electricity 104, and such solar devices are known to one of ordinary skill in the art.

In an embodiment, the absorbing surface 412 of the solar receptor 411 is shaped and designed to maximize the efficacy for converting the solar energy of the sunlight into electricity, such construction being known to one of ordinary skill in the art.

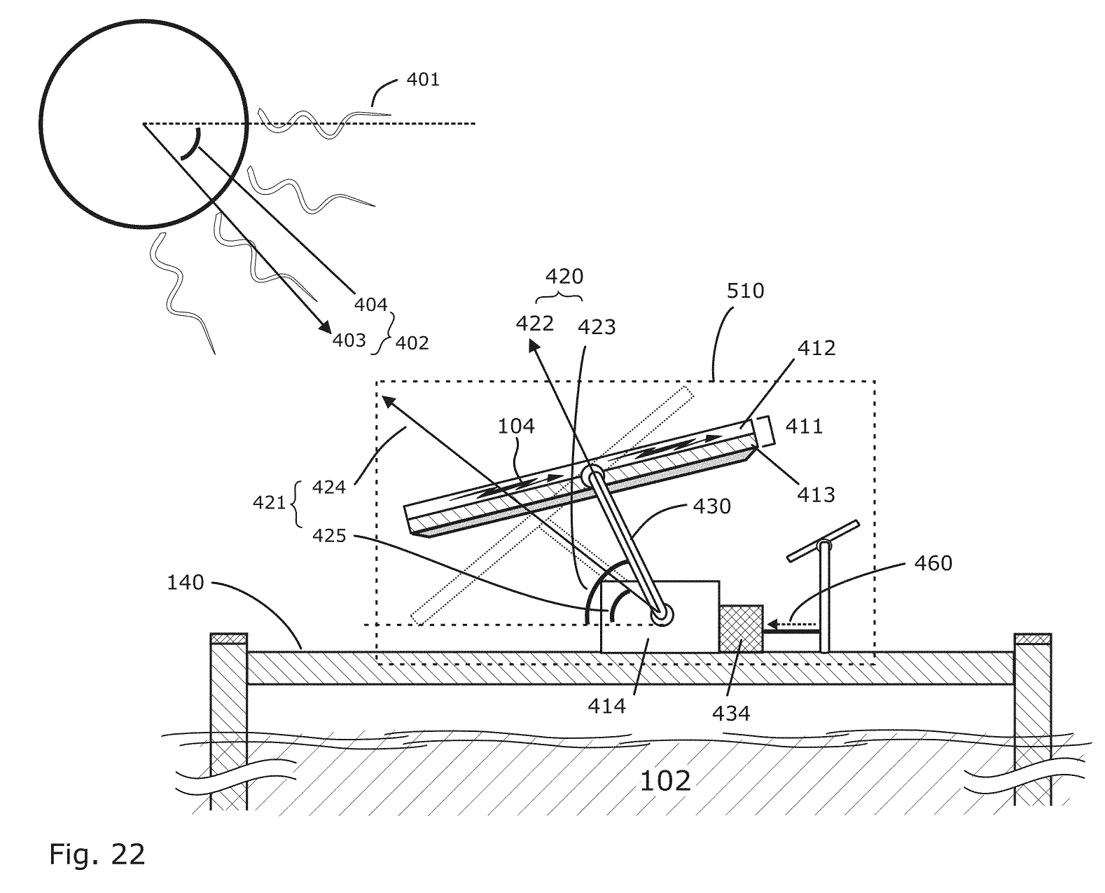

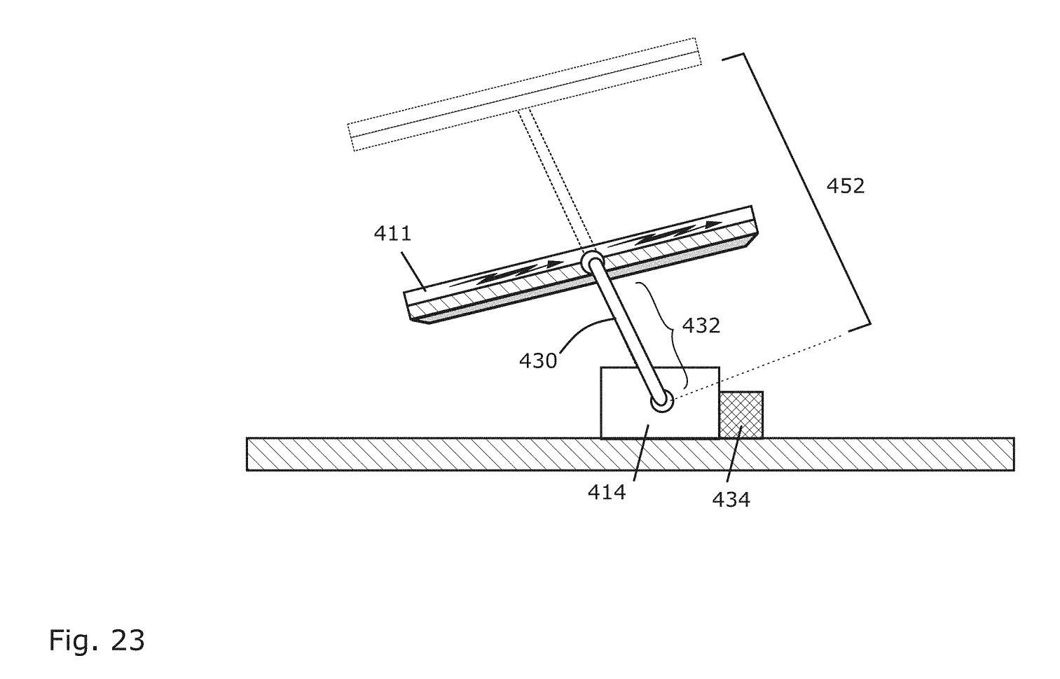

FIG. 22 shows a perspective view of an embodiment of a solar converter 510 in accordance with aspects of the present inventive concepts. The solar converter 510 comprises solar receptor 411 that has the absorbing surface 412 and the non-absorbing surface 413, and further comprises at least one rotator 414, at least one positioning arm 430, a controller 434, and at least one solar gauge 436.

The positioning arm 430 movably couples the non-absorbing surface 413 of the solar receptor 411 to the rotator 414 and the rotator 414 moves the positioning arm 430, whereby moving the solar receptor 411 from a first coordinate 420 to a second coordinate 421. The first coordinate 420 is defined by a first direction 422 and a first angle 423. The first direction 422 is one of 360 degrees relative to a compass orientation, and the first angle 423 is an angle of inclination of the absorbing surface 412 relative to a horizontal plane. The second coordinate 421 is defined by a second direction 424 and a second angle 425. The second direction 424 is one of 360 degrees relative to the compass orientation, and the second angle 425 is the angle of inclination of the absorbing surface 412 relative to the horizontal plane.

The rotator 414 is coupled to the support structure 140 and moves the positioning arm 430 to move the absorbing surface 412 of the solar receptor 411 from the first coordinate 420 to the second coordinate 421. Moving the rotator 414 from the first coordinate 420 to the second coordinate 421 changes at least one of the first direction 422 or the first angle 423 to at least one of the second direction 424 or the second angle 425.

The controller 434 is in communication with the rotator 414 and the solar gauge, and signals the rotator 414 to move the positioning arm 430 whereby moving the absorbing surface 412 of the solar receptor 411 from the first coordinate 420 to the second coordinate 421.

The solar gauge 436 calculates the solar coordinate 402 of the solar energy of the sunlight 401 wherein the solar coordinate 402 is defined by a solar direction 403 and a solar angle 404. The solar gauge 436 periodically calculates an optimal coordinate 438 having an optimal direction 440 and an optimal angle 442 relative to the solar coordinate 402. The optimal coordinate 438 maximizes the solar energy of the sunlight 401 exposed to the absorbing surface 412 of the solar receptor 411. The solar gauge 436 periodically generates a positioning signal 446 corresponding to the optimal coordinate 438 and communicates the positioning signal 446 to the controller 434 whereby instructing the controller 434 to move the solar receptor 411 to the optimal coordinate 438, whereby maximizing the solar energy of the sunlight 401 collected by the absorbing surface 412 at any given time.

FIG. 23 shows a perspective view of an embodiment of a solar converter 510 in accordance with aspects of the present inventive concepts, wherein the positioning arm 430 extends to adjust from a first length 432 to a second length 452. The positioning arm 430 couples the solar receptor 411 to the rotator 414, and the controller 434 signals the rotator 414 to extend or retract. Signaling the rotator to extend the positioning arm 430 lengthens the positioning arm 430 from the first length 432 to the second length 452, whereby elevating the solar receptor 411 relative to the rotator 414. Signaling the rotator 414 to retract the positioning arm 430 shortens the positioning arm 430 from the second length 432 to the first length 452, whereby lowering the solar receptor 411 relative to the rotator 414.

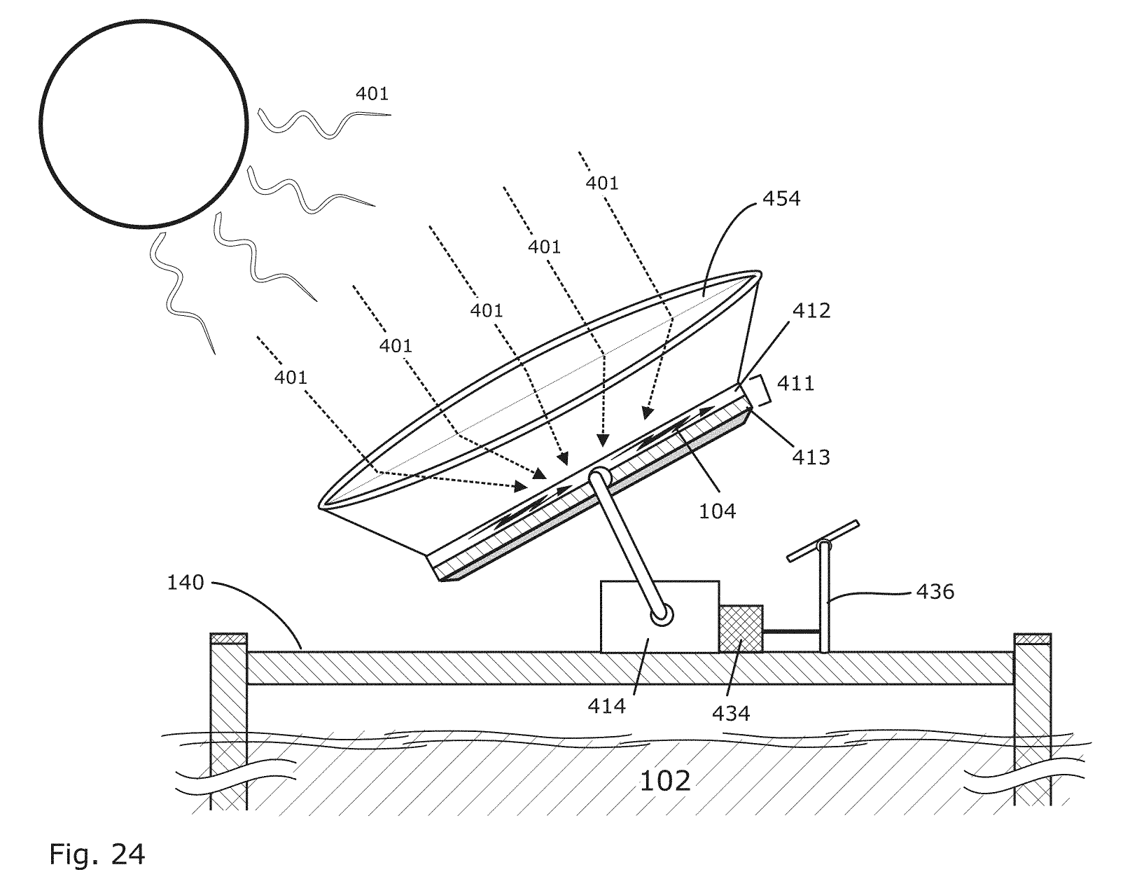

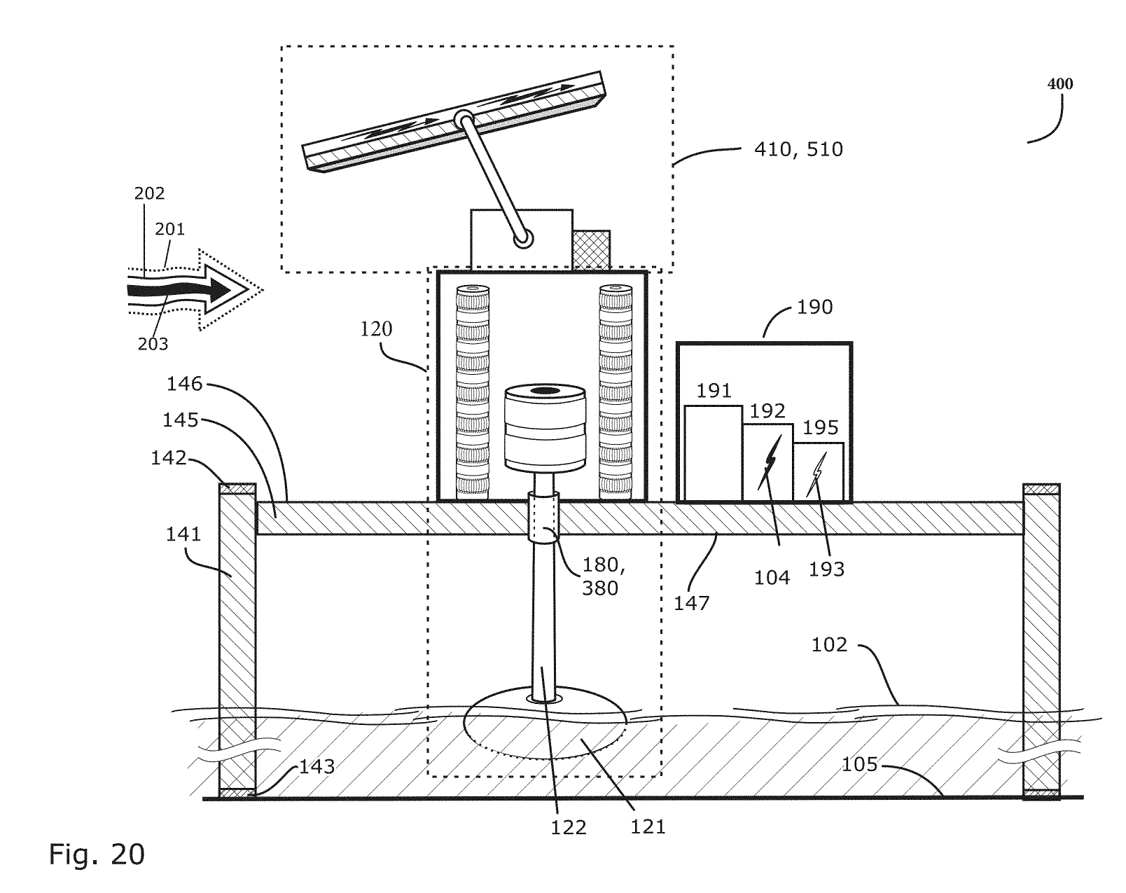

FIG. 24 shows a perspective view of an embodiment of a solar converter 410, 510 in accordance with aspects of the present inventive concepts. The solar converter 410, 510 further comprises at least one magnifying lens 454, having a first surface area 456, fixed adjacent the absorbing surface 412 of the solar receptor 411, wherein the absorbing surface 412 has a second surface area 458 less than the first surface area 456 of the magnifying lens 454. The solar energy of the sunlight 401 passing through the first surface area 456 of the magnifying lens 454 is concentrated onto the smaller second surface area 458 of the absorbing surface 412. In this way, a smaller area of the solar receptor 411 can generate a greater amount of the electricity 104.

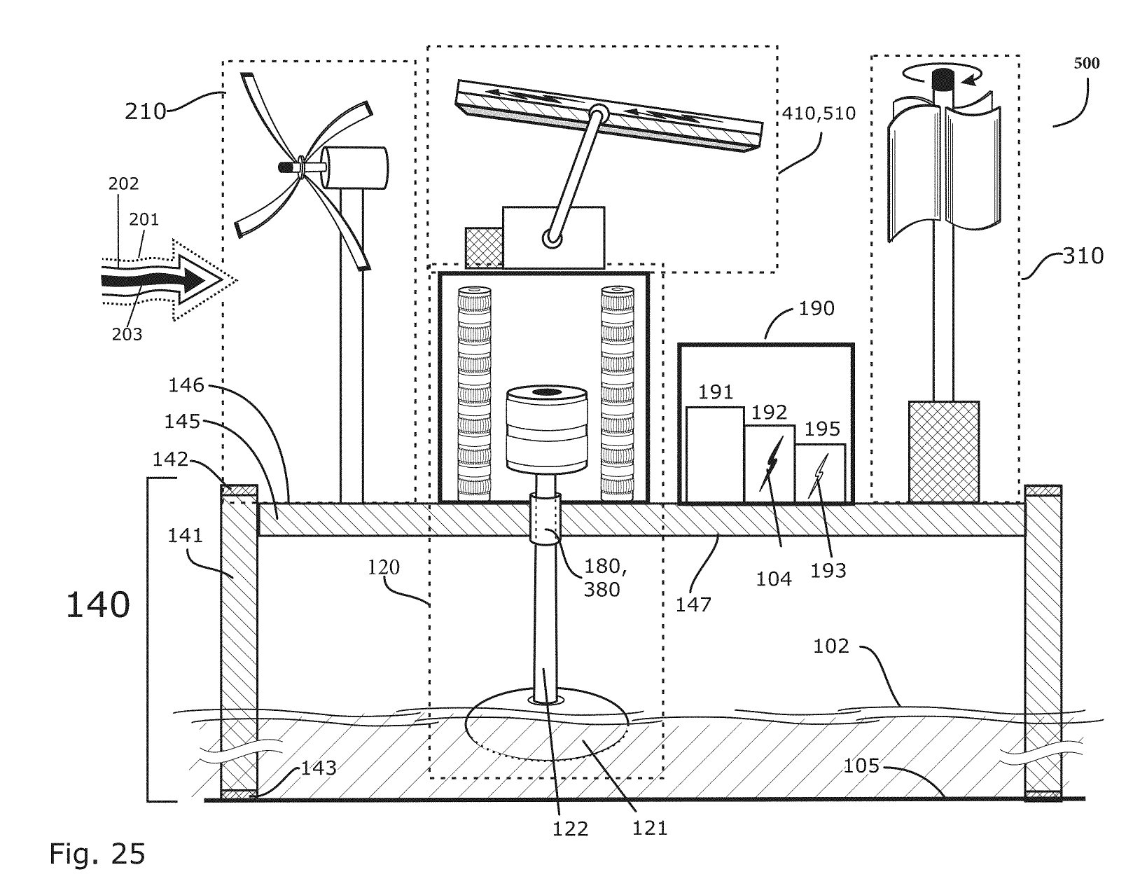

FIG. 25 shows a perspective view of an embodiment of an energy conversion system 500 in accordance with aspects of the present inventive concepts. The energy conversion system 500 comprises a support structure 140 coupled to at least one wave converter 120, and/or at least one wind converter 210 and/or at least one wind converter 310, and/or at least one solar converter 410 and/or at least one solar converter 510, and/or a central control unit 190, wherein the support structure 140 supports the wave converter 120, the wind converter 210 and/or the wind converter 310, the solar converter 410 and/or the solar converter 510, and/or the central control unit 190 at least partially above a body of water 102.

The foregoing inventive concepts may be embodied in many alternate forms and should not be construed as limited to example embodiments set forth herein. Accordingly, specific embodiments are shown by way of example in the drawings. It should be understood, however, that there is no intent to limit the inventive concepts to the particular forms disclosed, but on the contrary, the inventive concepts is to cover all modifications, equivalents, and alternatives falling within the spirit and scope of the claims.

1. An energy conversion system comprising:
at least one wave converter that converts kinetic energy of waves of a body of water into electricity, wherein the at least one wave converter comprises:
at least one floating assembly that at least partially floats on the body of water, the kinetic energy of the waves of the body of water applies a vertical force on the at least one floating assembly whereby moving the at least one floating assembly in response to the vertical force;
at least one rod assembly having a proximal end and a distal end, the distal end is coupled to the at least one floating assembly whereby coupling the distal end to the at least one floating assembly moves the at least one rod assembly in response to the vertical force applied to the at least one floating assembly;
at least one magnetic assembly, having at least one magnetic field having at least one magnetic strength, coupled to the at least one rod assembly whereby coupling the at least one magnetic assembly to the at least one rod assembly moves the at least one magnetic assembly in response to the vertical force applied to the at least one floating assembly; and
at least one coil assembly external to the at least one rod assembly, the at least one coil assembly is directly adjacent and at least partially surrounds the at least one magnetic assembly, the at least one magnetic assembly moves relative to the at least one coil assembly whereby generating the electricity at the at least one coil assembly.

2. The energy conversion system of claim 1 further comprising a housing having an opening, the proximal end of the at least one rod assembly extending through the opening, and the housing at least partially surrounding the at least one magnetic assembly and the at least one coil assembly.

3. The energy conversion system of claim 2 wherein the at least one coil assembly comprises at least one conductive wave coil having at least one second conductive wire coiled around at least one second conductive core, the at least one conductive wave coil passes through the at least one magnetic field in response to the vertical force moving the at least one magnetic assembly whereby generating the electricity at the at least one conductive wave coil.

4. The energy conversion system of claim 3 wherein the at least one magnetic assembly comprises at least one of at least one wave electromagnet or at least one wave permanent magnet.

5. The energy conversion system of claim 4 further comprising a support structure, coupled to the at least one wave converter, that supports the at least one wave converter at least partially above the body of water.

6. The energy conversion system of claim 5 wherein the support structure comprises:
at least one support leg having a top end and a bottom end, the bottom end is coupled to at least one of a ground surface or at least one support buoy, and the top end extends above the body of water; and
at least one platform having an upper surface and a lower surface, and the at least one platform is coupled to the at least one support leg whereby supporting the at least one platform horizontally above the body of water.

7. The energy conversion system of claim 5 further comprising:
at least one wave assembly controller, coupled to the at least one magnetic assembly, that adjusts the at least one magnetic strength of the at least one magnetic field; and
at least one wave gauge, in communication with the at least one wave assembly controller, that measures the vertical force applied to the at least one floating assembly, the at least one wave gauge generates a vertical force signal corresponding to the vertical force and communicates the vertical force signal to the at least one wave assembly controller to adjust the at least one magnetic strength relative to the vertical force.

8. The energy conversion system of claim 5 wherein the at least one magnetic assembly further comprises:
at least one power source, coupled to the at least one wave electromagnet, to power the at least one wave electromagnet; and
at least one charger, having at least one first conductive wire coiled around at least one first conductive core, coupled to the at least one power source, and the at least one charger is constructed and arranged to generate the electricity at the at least one charger whereby charging the at least one power source.

9. The energy conversion system of claim 8 wherein the at least one coil assembly further comprises:
at least one wave coil magnet, having at least one coil magnetic field, comprising at least one of at least one coil electromagnet or at least one coil permanent magnet, that generates the electricity at the at least one charger; and
a coil assembly power storage unit, coupled to the at least one conductive wave coil to store the electricity generated at the at least one conductive wave coil and to power the at least one wave coil magnet producing the at least one coil magnetic field, the at least one charger moves through the at least one coil magnetic field in response to the at least one floating assembly whereby generating the electricity at the at least one charger.

10. The energy conversion system of claim 5 further comprising at least one current inverter in communication with the at least one coil assembly, the electricity generated at the at least one coil assembly moves in a first direction when the at least one magnetic assembly moves in an upward direction from a first position relative to the at least one coil assembly to a second position higher than the first position in response to the at least one floating assembly moving in the upward direction, and the electricity generated at the at least one coil assembly moves in a second direction when the at least one magnetic assembly moves in a downward direction from a third position relative to the at least one coil assembly to a fourth position lower than the third position in response to the at least one floating assembly moving in the downward direction, and the at least one current inverter converts the electricity moving in the second direction into the electricity moving in the first direction, whereby all the electricity generated by the at least one magnetic assembly moving in the upward direction and in the downward direction is the electricity moving in the first direction.

11. The energy conversion system of claim 5 further comprising at least one rod guide having an interior surface and an exterior surface, the exterior surface is coupled to the support structure and the interior surface at least partially surrounds the at least one rod assembly.

12. The energy conversion system of claim 11 wherein the at least one rod assembly further comprises at least one rod magnet having a magnetic polarity, the interior surface of the at least one rod guide further having the magnetic polarity, and the magnetic polarity of the interior surface of the at least one rod guide opposes the magnetic polarity of the at least one rod magnet to form a frictionless relationship between the at least one rod assembly and the at least one rod guide.

13. The energy conversion system of claim 5 further comprising:
a central control unit coupled to the support structure, wherein the central control unit comprises:
a primary power storage unit, in communication with the at least one wave converter, that stores the electricity;
a power transformer, in communication with the primary power storage unit, that converts the electricity stored in the primary power storage unit into a modified electricity having a predetermined frequency waveform; and
a power transfer unit, in communication with the primary power storage unit and the power transformer, that controls transfer of the modified electricity from the power transformer unit.

14. An energy conversion system comprising:
at least one wind converter that converts kinetic energy of wind into electricity, the kinetic energy of the wind applies a horizontal force in a direction;
at least one wave converter that converts kinetic energy of waves of a body of water into the electricity, wherein the at least one wave converter comprises:
at least one floating assembly that at least partially floats on the body of water, the kinetic energy of the waves of the body of water applies a vertical force on the at least one floating assembly whereby moving the at least one floating assembly in response to the vertical force;
at least one rod assembly having a proximal end and a distal end, the distal end is coupled to the at least one floating assembly whereby coupling the distal end to the at least one floating assembly moves the at least one rod assembly in response to the vertical force applied to the at least one floating assembly;
at least one magnetic assembly, having at least one magnetic field having at least one magnetic strength, coupled to the at least one rod assembly whereby coupling the at least one magnetic assembly to the at least one rod assembly moves the at least one magnetic assembly in response to the vertical force applied to the at least one floating assembly; and
at least one coil assembly external to the at least one rod assembly, the at least one coil assembly is directly adjacent and at least partially surrounds the at least one magnetic assembly, the at least one magnetic assembly moves relative to the at least one coil assembly whereby generating the electricity at the at least one coil assembly; and
a support structure, coupled to the at least one wave converter and the at least one wind converter, that supports the at least one wave converter and the at least one wind converter at least partially above the body of water.

15. The energy conversion system of claim 14 wherein the at least one coil assembly comprises at least one conductive wave coil having at least one second conductive wire coiled around at least one second conductive core, the at least one conductive wave coil moving relative to the at least one magnetic field in response to the at least one floating assembly, whereby generating the electricity at the at least one conductive wave coil.

16. The energy conversion system of claim 15 wherein the at least one magnetic assembly comprises at least one of at least one wave electromagnet or at least one wave permanent magnet.

17. The energy conversion system of claim 14 wherein the support structure comprises:
at least one support leg having a top end and a bottom end, the bottom end is coupled to at least one of a ground surface or at least one support buoy, and the top end extends above the body of water; and
at least one platform having an upper surface and a lower surface, and the at least one platform is coupled to the at least one support leg whereby supporting the at least one platform horizontally above the body of water.

18. The energy conversion system of claim 14 further comprising a housing having an opening, the proximal end of the at least one rod assembly extending through the opening, and the housing at least partially surrounding the at least one magnetic assembly and the at least one coil assembly.

19. The energy conversion system of claim 14 further comprising:
at least one wave assembly controller, coupled to the at least one magnetic assembly, that adjusts the at least one magnetic strength of the at least one magnetic field; and
at least one wave gauge, in communication with the at least one wave assembly controller, that measures the vertical force applied to the at least one floating assembly, the at least one wave gauge generates a vertical force signal corresponding to the vertical force, and communicates the vertical force signal to the at least one wave assembly controller to adjust the at least one magnetic strength relative to the vertical force.

20. The energy conversion system of claim 16 wherein the at least one magnetic assembly further comprises:
at least one power source to power the at least one wave electromagnet; and
at least one charger having at least one first conductive wire coiled around at least one first conductive core, the at least one charger is constructed and arranged to generate the electricity at the at least one charger whereby charging the at least one power source.

21.-70. (canceled)

71. An energy conversion method comprising:
providing at least one wave converter that converts kinetic energy of waves of a body of water into electricity, wherein providing the at least one wave converter comprises:
providing at least one floating assembly that at least partially floats on the body of water, the kinetic energy of the waves of the body of water applies a vertical force on the at least one floating assembly whereby moving the at least one floating assembly in response to the vertical force;
providing at least one rod assembly having a proximal end and a distal end, the distal end is coupled to the at least one floating assembly whereby coupling the distal end to the at least one floating assembly moves the at least one rod assembly in response to the vertical force applied to the at least one floating assembly;
providing at least one magnetic assembly, having at least one magnetic field having at least one magnetic strength, coupled to the at least one rod assembly whereby coupling the at least one magnetic assembly to the at least one rod assembly moves the at least one magnetic assembly in response to the vertical force applied to the at least one floating assembly; and
providing at least one coil assembly external to the at least one rod assembly, the at least one coil assembly is directly adjacent and at least partially surrounds the at least one magnetic assembly, the at least one magnetic assembly moves relative to the at least one coil assembly whereby generating the electricity at the at least one coil assembly.

72. The energy conversion method of claim 71 wherein providing the at least one coil assembly comprises providing at least one conductive wave coil having at least one second conductive wire coiled around at least one second conductive core, the at least one conductive wave coil passes through the at least one magnetic field in response to the vertical force moving the at least one magnetic assembly whereby generating the electricity at the at least one conductive wave coil.

73. The energy conversion method of claim 72 wherein providing the at least one magnetic assembly comprises providing at least one of at least one wave electromagnet or at least one wave permanent magnet.

74. The energy conversion method of claim 71 further comprising providing a support structure, coupled to the at least one wave converter, that supports the at least one wave converter at least partially above the body of water.

75. The energy conversion method of claim 71 further comprising:
providing at least one wave assembly controller, coupled to the at least one magnetic assembly, that adjusts the at least one magnetic strength of the at least one magnetic field; and
providing at least one wave gauge, in communication with the at least one wave assembly controller, that measures the vertical force applied to the at least one floating assembly, the at least one wave gauge generates a vertical force signal corresponding to the vertical force, and communicates the vertical force signal to the at least one wave assembly controller to adjust the at least one magnetic strength relative to the vertical force.

76. The energy conversion method of claim 71 further comprising providing at least one current inverter in communication with the at least one coil assembly, the electricity generated at the at least one coil assembly moves in a first direction when the at least one magnetic assembly moves in an upward direction from a first position relative to the at least one coil assembly to a second position higher than the first position in response to the at least one floating assembly moving in the upward direction, and the electricity generated at the at least one coil assembly moves in a second direction when the at least one magnetic assembly moves in a downward direction from a third position relative to the at least one coil assembly to a fourth position lower than the third position in response to the at least one floating assembly moving in the downward direction, and the at least one current inverter converts the electricity moving in the second direction into the electricity moving in the first direction, whereby all the electricity generated by the at least one magnetic assembly moving in the upward direction and in the downward direction is the electricity moving in the first direction.

77. The energy conversion method of claim 74 further comprising providing at least one rod guide having an interior surface and an exterior surface, the exterior surface is coupled to the support structure and the interior surface at least partially surrounds the at least one rod assembly.

78.-80. (canceled)
